(19) United States
(12) Patent Application Publication
(10) Pub. No.: US 2026/0330492 A1
(43) Pub. Date: Oct. 22, 2026

(54) METHODS, SYSTEMS, AND APPARATUSES FOR DETERMINING DIGITAL BOOK SALES

(71) Applicant: Bookstat LLC, El Segundo, CA (US)

(72) Inventor: Paul Abbassi, Palo Alto, CA (US)

(21) Appl. No.: 19/709,418

(22) Filed: Jun. 16, 2026

Related U.S. Application Data
(62) Division of application No. 18/731,893, filed on Jun. 3, 2024.
(60) Provisional application No. 63/470,279, filed on Jun. 1, 2023.

(51) Int. Cl. G06Q 30/0203

(52) U.S. Cl. CPC G06Q 30/0203

(57) ABSTRACT

Methods, systems, and apparatuses are provided for determining digital book sales. A plurality of digital book data for a plurality of digital book titles for a period and associated with a plurality of retailers may be received by one or more computing devices. A sales rank may be determined for the plurality of digital book titles for each retailer. A weighted unit sales amount may be determined for each digital book title of the plurality of digital book titles for each retailer. An optimal curve fit of the sales rank to the weighted unit sales amount may be determined for each digital book title of the plurality of digital book titles for each retailer. A period unit sales amount may be determined for each digital book title for the plurality of retailers.

### CROSS-REFERENCE TO RELATED APPLICATIONS

This application claims priority under 35 U.S.C. § 121 to, and is a divisional of, U.S. patent application Ser. No. 18/731,893 filed on Jun. 3, 2024, which claims priority to and the benefit of U.S. Provisional Patent Application No. 63/470,279, filed Jun. 1, 2023, the entire contents of each of which are hereby incorporated herein by reference in their entirety for all purposes.

### BACKGROUND

Within the book publishing industry it can be difficult to locate and quantify accurate data on sales of digital books (e.g., electronic books (e-books) and/or audiobooks). In contrast to physical printed books, which can be tracked throughout their supply chain in quantifiable and measurable numbers for each individual book title that is printed, shipped, sold, and returned, digital books are fungible digital assets whose online sales or purchases cannot be similarly tracked and estimated.

Digital books are sold through online retailers. However, while these online retailers do report confidentially to each publisher the sales of their own individual titles as part of their royalty remuneration, these online retailers do not publicly report sales in either aggregate/overall numbers or for individual digital book titles. Conventional systems have attempted to address this problem by approaching a few of the largest publishers of printed books, and convincing them to share their e-book sales data. These conventional systems have resulted in very limited and problematic data products. The panel of large publishers submitting their e-book sales data to these conventional systems in total make up a very small (and shrinking) fraction of the broader e-book seller market. In addition, due to punitive e-book pricing policies by those same participating large publishers, in an attempt to make print books more attractive than e-books to consumers, and thereby preserve their own merchandising advantages in physical print bookstores, the conventional product data since 2013 has trended in an opposite direction than the broader e-book market. This results in reporting of shrinking e-book sales by the participating publishers, when overall e-book digital book sales are actually increasing.

### SUMMARY

It is to be understood that both the following general description and the following detailed description are exemplary and explanatory only and are not restrictive. Methods, systems, and apparatuses for determining digital book sales are described.

Methods, systems, and apparatuses are provided for determining digital book sales are described herein. In one example embodiment, a method for determining digital book sales is described. The method may include receiving a plurality of digital book data for a plurality of digital book titles for a period and associated with a plurality of retailers. The plurality of digital book data may be received by one or more computing devices. The method may include determining a sales rank for the plurality of digital book titles for each retailer of the plurality of retailers. For example, the sales rank may be determined based on based on the plurality of digital book data. The method may include determining a weighted unit sales amount for each digital book title of the plurality of digital book titles for each retailer of the plurality of retailers. For example, the weighted unit sales amount may be determined based on one or more of the sales rank and/or the plurality of digital book data. The method may include determining an optimal curve fit of the sales rank to the weighted unit sales amount for each digital book title of the plurality of digital book titles for each retailer of the plurality of retailers. For example, the optimal curve fit may include an optimal log quadratic curve fit of the sale rank to the weighted unit sales amount. The method may include determining a period unit sales amount of each digital book title for the plurality of retailers. For example, the period unit sales amount of each digital book title may be based on the optimal curve fit for each book title of the plurality of book titles for each retailer of the plurality of retailers.

In another example embodiment, a method for determining digital book sales is described. The method may include receiving a plurality of digital book data for a plurality of digital book titles for a period and associated with a plurality of retailers. For example, the plurality of digital book data may be received by one or more computing devices. The method may include determining a first portion of the plurality of digital book titles in a total sales ranking for each respective retailer of the plurality of retailers. For example, the first portion of the plurality of digital book titles may be determined based on the plurality of digital book data. The method may include determining, for each respective digital book title of the first portion of the plurality of book titles, a subgenre ranking in at least one subgenre for that respective digital book title. The method may include determining a list rank multiplier for each respective digital book title of the first portion of the plurality of digital book titles. For example, the list rank multiplier may be determined based on the subgenre ranking in at least one subgenre for each respective digital book title. The method may include determining an approximate sales rank for each of the plurality of digital book titles. For example, the approximate sales rank may be determined based on the list rank multiplier for each respective digital book title of the first portion of the plurality of digital book titles. The method may include determining a weighted unit sales amount for each digital book title of the plurality of digital book titles for each retailer of the plurality of retailers. For example, the weighted unit sales amount may be determined based on the approximate sales rank and the plurality of digital book data. The method may include determining an optimal curve fit of the approximate sales rank to the weighted unit sales amount for each digital book title of the plurality of digital book titles for each retailer of the plurality of retailers. For example, the optimal curve fit may include an optimal log quadratic curve fit. The method may include determining a period unit sales amount of each digital book title for the plurality of retailers. For example, the period unit sales may be determined based on the optimal curve fit for each book title of the plurality of book titles for each retailer of the plurality of retailers.

In another example embodiment, a method for determining digital book sales is described. The method may include receiving a plurality of digital book data for a plurality of digital book titles for a period and associated with a retailer. The plurality of digital book data may be received by a computing device. The method may include determining daily sales data not available for at least one book format for the plurality of digital book titles. For example, the determination may be based on an evaluation of the plurality of digital book data. The method may include determining a first portion of the plurality of digital book titles in the at least one book format in a sub-genre sales ranking for the retailer. For example, the first portion of the plurality of digital book titles may be determined based on the plurality of digital book data. The method may include determining, for each respective digital book title of the first portion of the plurality of book titles, a total sales ranking for that respective digital book title. For example, the total sales ranking may be determined based on the plurality of digital book data. The method may include determining a weighted unit sales amount for each respective digital book title of the plurality of digital book titles. For example, the weighted unit sales amount may be determined based on the total sales ranking. The method may include determining an interpolated weighted unit sales amount for each respective digital book title in the at least one book format. For example, the interpolated weighted unit sales amount may be determined based on the weighted unit sales amount. The method may include determining an optimal curve fit of the sales rank to the interpolated weighted unit sales amount for each digital book title of the plurality of digital book titles in the at least one format for the retailer. For example, the optimal curve fit may include an optimal log quadratic curve fit. The method may include determining a period unit sales amount of each digital book title in the at least one format for the retailer. For example, the period unit sales amount may be determined based on the optimal curve fit for each book title of the plurality of book titles in the at least one format for the retailer.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system;

FIG. 2 shows a flowchart for an example method;

FIG. 3 shows a flowchart for an example method;

FIG. 4 shows a flowchart for an example method;

FIG. 5 shows a flowchart for an example method;

FIG. 6 shows a flowchart for an example method;

FIG. 7 shows an example graphical representation of data; and

FIG. 8 shows an example graphical representation of data.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

Embodiments of this disclosure include computing systems, computing devices, computer-implemented methods, and computer program products that, individually or in combination, can be used for identification of electronic books for audiobook publication. Such identification can be based on generation of prediction attributes according to a predictive model. The predictive model can be embodied on a machine-learning model trained using target electronic books as a training set and various attributes of the target electronic books as feature inputs. A target electronic book is an electronic book that published prior to the publication of the electronic book as a successful audiobook. Success can be established using performance metrics, such as number of sales and/or review ratings, and a defined success rule. The various attributes include static attributes (author and genre, for example) and dynamic attributes representing respective performance metrics. Examples of the performance metrics include review rating, sales amounts, sale revenues, or similar quantities.

By applying the trained machine-learning model to values of static and dynamic attributes of a particular electronic book, a prediction attribute can be determined. The A prediction attribute can include a score (referred to as candidacy score) that defines a probability of an electronic book yielding a successful audiobook. Thus, the candidacy score represents a strength assessment of the electronic book as a candidate for audiobook publication. A candidacy score that meets or exceeds a defined threshold value can identify an electronic book as a good candidate for audiobook publication.

Accordingly, a trained predictive model can have optimized parameters that can map the group of performance signals to select electronic books corresponding to successful audiobooks. As such, the trained predictive model can weigh the various static and dynamic attributes used as feature inputs in order to predict electronic books that would yield a successful audiobook.

A trained predictive model can be applied to performance signals for a particular electronic book in order to determine if the particular electronic book is a candidate for audiobook publication. The particular electronic book can be included in a catalog of a digital marketplace. The digital marketplace can be administered by a branded retailer or an entity that permits participation of disparate retailer within the digital marketplace.

Prediction attributes in accordance with this disclosure constitute a data signal that can be incorporated into dashboard applications or other typed of analytics applications.

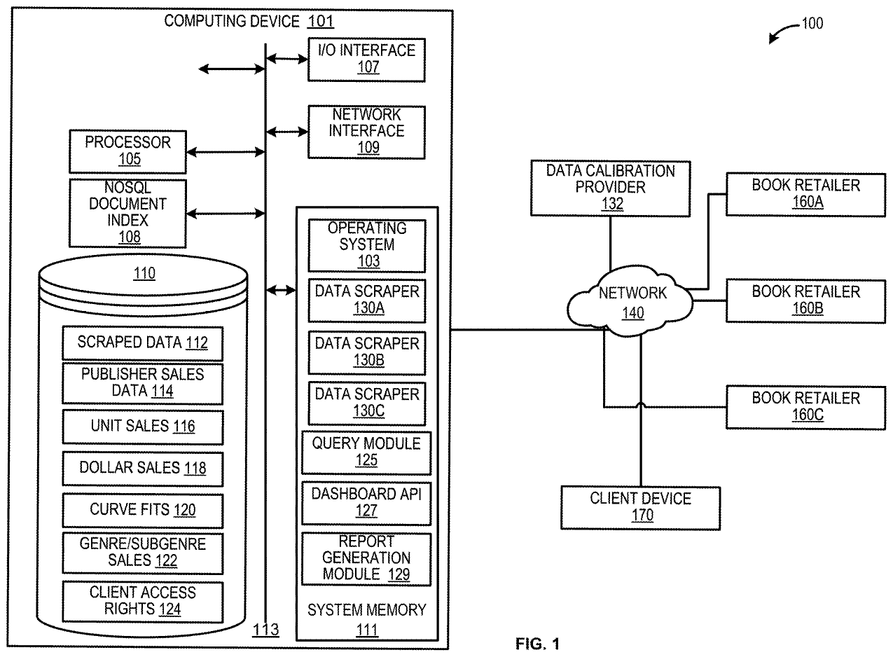

The methods and systems disclosed herein may be computer-implemented. FIG. 1 shows a block diagram depicting a system/environment 100 comprising non-limiting examples of a computing device 101, one or more data calibration providers 132, a plurality of digital book retailers 160A-C, and one or more client devices connected through a network 140. Each of the computing device 101, data calibration provider 132, digital book retailers 160A-C and client device 170 may be or comprise a computing device. In an aspect, some or all steps of any described method may be performed on/by any of the computing devices as described herein. The computing device 101 may comprise one or multiple computers configured to generate, retrieve, and/or store digital book data. For example, the computing device 101 may comprise multiple computing devices or servers that communicate via the network 140 or another network. For example, the computing device 101 may be a cloud computing device.

The computing device 101 may be a digital computer that, in terms of hardware architecture, generally includes a processor 105, system memory 111, input/output (I/O) interfaces 107, a noSQL document index 108, a database 110, and network interfaces 109. The computing device 101 may further include one or more (e.g., a plurality of) data scrapers 130A-C, a query module 125, a dashboard API, and a report generation module 129. Those of ordinary skill in the art will recognize that the computing device 101 may include many other hardware and software components beyond that described herein. Furthermore, the components of the computing device 101 discussed herein are for example purposes only and are not meant to be limiting in capability or scope. These components (105, 107, 108, 109, 110, 111, 125, 127, and 129) may be communicatively coupled via a local interface 113. The local interface 113 may be, for example, but not limited to, one or more buses or other wired or wireless connections, as is known in the art. The local interface 113 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 may be a hardware device for executing software, particularly that stored in system memory 111. The processor 105 may be any custom made or commercially available processor, a central processing unit (CPU), an auxiliary processor among several processors associated with the computing device 101, a semiconductor-based microprocessor (in the form of a microchip or chip set), or generally any device for executing software instructions. When the computing device 101 is in operation, the processor 105 may execute software stored within the system memory 111, to communicate data to and from the system memory 111, and to generally control operations of the computing device 101 pursuant to the software.

The I/O interfaces 107 may be used to receive user input from, and/or for providing system output to, one or more devices or components. User input may be provided via, for example, a keyboard and/or a mouse. System output may be provided via a display device and a printer (not shown). I/O interfaces 107 may include, for example, a serial port, a parallel port, a Small Computer System Interface (SCSI), an infrared (IR) interface, a radio frequency (RF) interface, and/or a universal serial bus (USB) interface.

The network interface 109 may be used to transmit and receive from the computing device 101 on the network 140. The network interface 109 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 109 may include address, control, and/or data connections to enable appropriate communications on the network 140.

The system memory 111 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 111 may incorporate electronic, magnetic, optical, and/or other types of storage media. Note that the system memory 111 may have a distributed architecture, where various components are situated remote from one another, but may be accessed by the processor 105.

The software in system memory 111 may include one or more software programs, each of which comprises an ordered listing of executable instructions for implementing logical functions. In the example of FIG. 1, the software in the system memory 111 of the computing device 101 may comprise a suitable operating system (O/S) 103, one or more (e.g., a plurality of) data scrapers 130A-C, a query module 125, a dashboard API 127, and a report generation module 129. For example, the operating system 103 essentially controls the execution of other computer programs and provides scheduling, input-output control, file and data management, memory management, and communication control and related services. For example, each data scraper of the plurality of data scrapers 130A-C may be configured to retrieve or receive digital book data on a periodic (e.g., daily, 24 hours, weekly, monthly, quarterly) basis from one or more digital book retailer websites 160A-C. For example, the data scrapers 130A-C may comprise a plurality, for example, 50-100, data scrapers 130A-C comprising bot servers. For example, each data scraper 130A-C, may be capable of operating several hundred independent collection process threads with the plurality of digital book retailer websites 160A-C to receive or retrieve the digital book data, while coordinating with each other through central tracking to avoid unnecessary duplicate collection, and to ensure redundancy so that the work of any collection process thread can be taken over by another thread or another data scraper 130A-C if the original collection process thread or data scraper 130A-C is unable to collect the digital book data.

For example, the dashboard API 127 may be configured to generate and cause to be output an operational dashboard to a plurality of client devices 170. The dashboard may provide a mechanism for users associated with a particular client device 170 to request digital book data, such as sales amounts and dollar sales for one or more digital book titles and/or a particular digital book format (e.g., electronic book, audiobook, print book) for a digital book title. For example, the dashboard API 127 may work with the query module 125 to provide a mechanism for receiving the queries from the client devices 170.

For example, the query module 125 may be configured to receive queries for digital book data from a plurality of client devices 170. The query module 125 may evaluate the data in the database 110, such as scraped data 112, publisher sales data 114, unit sales data, dollar sales data, and/or genre/subgenre sales 122 to determine information that satisfies the received query. For example, the query module 125 may be configured to operate with the report generation module 129 to generate and cause to be output reports in response to the received queries. The report generation module 129 may be configured to send the reports to the particular client device 170 that generated the query.

For purposes of illustration, application programs and other executable program components such as the operating system 103, data scrapers 130A-C, query module 125, dashboard API 127, and report generation module 129 are shown herein as discrete blocks, although it is recognized that such programs and components may reside at various times in different storage components of the computing device 101. An implementation of the computing device 101 may be stored on or transmitted across some form of computer-readable media. Any of the disclosed methods may be performed by computer-readable instructions embodied on computer-readable media. Computer-readable media may be any available media that may be accessed by a computer. For example, the computer-readable media may be non-transitory computer-readable media. By way of example and not meant to be limiting, computer-readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

The data calibration provider 132 may be one of a plurality of data calibration providers providing digital book data to the computing device 101. The data calibration provider 132 may be or comprise a computing device. The data calibration provider 132 may be operated by or be associated with one or more book publishers. The data calibration provider 132 may provide actual sales data for a plurality of digital book titles in a plurality of digital book formats.

Each digital book retailer 160A-C may be or comprise a computing device. For example, each digital book retailer 160A-C may comprise a client-facing website providing digital book data on a plurality of digital book titles. For example, each digital book retailer 160A-C may be accessed via the Internet by the computing device 101. For example, each client device 170 may comprise a computing device. For example, each client device 170 may be a laptop computer, a desktop computer, a computing station, a tablet device, a mobile computing device, a mobile phone, a peer device, a server, a network computer, or the like. A user may submit queries via the client device 170 to the computing device 101 for digital book data of interest to the user via the network 140 or another network.

The network 140 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent on the network 140 via a variety of transmission paths along the data, power, communication, and/or content data transmission system, including wireless paths (e.g., satellite paths, Wi-Fi paths, cellular paths, etc.) and terrestrial paths (e.g., wired paths (e.g., coaxial cable or fiber-optic), a direct feed source via a direct line, etc.).

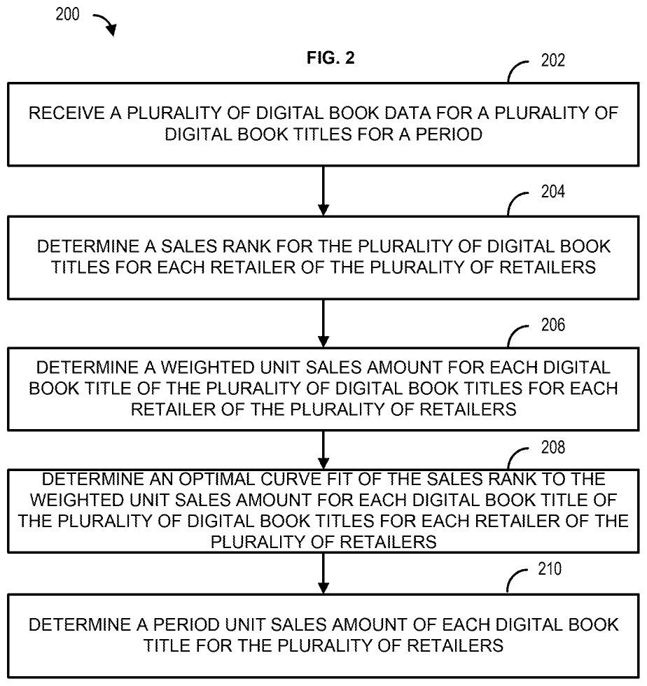

FIG. 2 shows a flowchart of an example method 200 for determining digital book sales at a book title-level basis and/or a digital book format basis for a given market. For example, the method 200 may be completed by the computing device 101 or any other computing device described herein. For example, the market may be a country, a group of countries, a region, or the like. For example, a digital book may be any kind of book sold via an electronic network or the Internet. This may include print books (e.g., physical hard-back or paperback books) sold via the electronic network or the internet. For example, a digital book format may be one or more of an electronic book (or e-book), an audio book, or a print book.

At 202, a plurality of digital book data for a plurality of digital book titles for a period of time may be received or retrieved. For example, the plurality of digital book data may be received by the computing device 101 or any other computing device described herein. For example, the plurality of digital book data may be received or retrieved from one or more (e.g., a plurality) of digital book retailer websites 160A-C. For example, the period of time or time period may be a day, 24 hours, a week, a month, a year, or a quarter of a calendar year. For example, the plurality of digital book data may comprise digital book title-level metadata. For example, the plurality of digital book data (e.g., the digital book title-level metadata) may comprise one or more of a sales price, a list price, a total sales ranking, a genre sales ranking, or a subgenre sales ranking.

For example, the plurality of digital book data for the plurality of digital book titles may include raw data collected to be able compute market-wide digital book sales. For example, the plurality of digital book data may include millions of webpages captured on a periodic (e.g., daily, 24 hour, weekly, monthly, quarterly) basis from digital (e.g., online) book retailers. For example, the plurality of digital book data may comprise a plurality (e.g., tens of thousands) of genre-specific retailer bestseller lists with relative sales rankings for digital books in each or a particular book format (e.g., e-book, audiobook, and print books) in those genres, such as, but not limited to, Top 100 Cozy Mysteries, Top 100 Biographies of Sports Leaders, Top 100 Teen & Young Adult Urban Fantasy Novels, etc.

For example, the plurality of digital book data may comprise a plurality (e.g., thousands, millions, or more) of retailer “product description” webpages for specific e-books, audiobooks, and print books that the one or more computing devices discover on the above bestseller lists, as “also-boughts” associated with other books (e.g., “readers who bought this book also bought these other books . . . ”) or which are determined herein to be likely nonzero-sellers that period due to having nonzero sales over the previous seven days. For example, the product-description webpages may contain relevant digital book metadata. For example, the digital book metadata may comprise one or more of the title, author, publisher label, publication date, retailer stock keeping unit (SKU), international standard book number (ISBN), and/or narrator (for audiobooks). These pages and the digital book metadata may also contain sale price for the digital book in the particular format, list price for the digital book in the particular format, and (for some retailers) an total sales ranking for that digital book out of all the digital books of that format (e.g., e-book, audiobook, print book, etc.) sold at that retailer. For example, the plurality of digital book data may comprise a plurality of ISBN cross-lookups of digital books found at one retailer to discover their equivalent SKUs, data, and sales at other retailers. For example, the plurality of digital book data may comprise a plurality of book cover-image matching scores (via machine-learning analysis) for pairs of non-ISBN-bearing book SKUs at different retailers that fuzzy metadata matching, using machine-learning method disclosed herein, indicates are likely to be different-retailer editions of the same digital book title.

Many digital (e.g., online) retailers may have sophisticated “bot blockers” and active countermeasures in place (like CAPTCHAs) to attempt to block programmatic web-scraping-based data collection at scale. The architecture of the systems and methods disclosed herein is designed to counter these mechanisms with a combination of robust and redundant collection strategies, a fleet of high-powered data scrapers 130A-C, aggressive brute force retry strategies (which may average many hundreds of millions of page requests per period (e.g., day)), and the routing of all automated webpage HTTP requests through hundreds of thousands of disparate IP addresses within each market or portion of the market (e.g., city, state, country, or group of countries) to be evaluated and for which digital book data will be collected.

The pluggable proxy architecture of the systems and methods disclosed herein allow for use of an interchangeable selection of different proxy vendors to provide the hundreds of thousands of country-specific proxy IP addresses through which the plurality of digital book data is retrieved or received on a periodic (e.g., daily, 24 hour, weekly, monthly, quarterly, etc.) basis, such as millions of pages of HTML digital book rankings and book product pages from retailer websites. At any given time, up to 3 or more different proxy-IP vendors per market may be used to ensure no single points of failure and to provide built-in automated failover/redundancy as each individual proxy vendor's effectiveness (capture efficiency at evading bot-blockers, total network/page capture rate/throughput, and price/performance ratio) varies independently over time.

For each retailer and digital book format sold at each retailer, the systems and methods disclosed herein may determine, to within precise statistical limits, the shape of the “long tail” of that distribution, and therefore, roughly what overall sales ranking may correspond to zero sales in the last period (e.g., last day, 24 hours, week, month, quarter, etc.). The systems and methods disclosed herein may use this information to “steer” the collection process throughout the period reactively and in real-time, to increase the possibility that the digital book sales data captures data on all digital books selling at least one copy during the particular period, while capturing data on as few digital books that had zero sales during the period.

At 204, a sales rank may be determined for the plurality of digital book titles for each retailer of the plurality of retailers. For example, the sale rank may be determined by the computing device 101 or any other computing device disclosed herein. For example, the sales rank may be determined based all, any, or at least a portion of the plurality of digital book data. For example, the sales rank may be an overall sales rank for all digital book titles in all formats, an overall sales rank for all digital book titles in a particular format, a genre-specific sales rank for all digital book titles in that genre in any format, a genre-specific sales rank for all digital book titles in that genre in a particular format, a subgenre-specific sales rank for all digital book titles in that subgenre in any format, or a subgenre-specific sales rank for all digital book titles in that subgenre in a particular format.

For example, determining a sales rank for each digital book title may include an analysis of historic sales-ranking data in combination with sales actuals for those digital book titles. It may also include running “impulse response” measurement experiments via timed purchases of specific titles where real-time access to title-specific sales history and sales rankings at each retailer is accessible. For example, doing so allows for the determination of the mathematical structure of each retailer's sales-ranking algorithm. For example, the sales rank computation may take the form of:

$$SalesRank = f ( WUS )$$

where sales rank is a function of weighted unit sales (WUS). For example, the weighted unit sales may be the weighted cumulative unit sales for the particular digital book title. For example, the weighted unit sales may be a recency-weighted cumulative unit sales for the particular digital book title.

At 206, a weighted unit sales amount for each digital book title of the plurality of digital book titles for each retailer of the plurality of retailers may be determined. For example, the determination may be made by the computing device 101 or any other computing device described herein. For example, the parameterized form of weighted unit sales for each book title may be quite consistent across different retailers and digital book formats, with only the specific numerical parameters varying by retailer (and more rarely, by format within a retailer). For example, the weighted unit sales (WUS) for a given retailer (r) and digital book format (f) may be calculated for each specific digital book title as:

$${WUS}_{r , f} = {\sum }_{n = 0}^{- ∞} {{s}_{n} [ \frac{1}{{D}_{r , f}} ]}^{{t}_{n}}$$

where tₙ=a particular past time period (for example, t₀=today, t₋₁=yesterday, t₋₂=the day before yesterday, etc.—although hours may be substituted for days in certain example embodiments for more accuracy)
sₙ=the number of unit sales of that digital book title occurring at time tₙ (or more precisely, the number of unit sales of that digital book title occurring between time tₙ₋₁ and tₙ)
D_{r,f}=a retailer- and format-specific daily (or hourly) decay rate, which is the rate at which the contribution to a digital book title's WUS by older sales decays over time relative to the contribution of more recent sales to that digital book title's WUS

For example, with weighted unit sales determined in this form, for a retailer of the plurality of retailer, the process need only record the latest value of WUS computed for each digital book title, and then update it over time incrementally to incorporate newer sales (or even in the absence of new sales) using, for example, the following:

$${WUS}_{{t}_{n + 1}} = ( {[ \frac{1}{{D}_{r , f}} ]}^{( {t}_{n + 1} - {t}_{n} )} {WUS}_{{t}_{n}} ) + {s}_{n + 1}$$

where tₙ₊₁=the current time period
tₙ=the previous time period
WUSₜ_{ₙ}=the previously computed WUS value for t₁
WUSₜ_{ₙ₊₁}=the updated WUS value at tₙ₊₁
sₙ₊₁=the number of unit sales of that digital book title occurring between time tₙ and tₙ₊₁
D_{r,f}=the retailer- and format-specific daily (or hourly) decay rate, which is the rate at which the contribution to a digital book title's WUS by older sales decays over time relative to the contribution of more recent sales to that digital book title's WUS.

For example, when the daily sales cadence for a digital book title is uniformly or substantially uniformly consistent (e.g., always or usually X sales per day) or even approximately consistent, the determination of weighted unit sales for a digital book title at a particular retailer of the plurality of retailers becomes:

$${WUS}_{r , f} = {s}_{d} ( \frac{1}{1 - {D}_{r , f}} )$$

where WUS_{r,f}=the steady—state WUS value for the digital book title
WUSₜ_{ₙ₊₁}=the updated WUS value at tₙ₊₁
s_{d}=the uniform or substantially uniform number of daily unit sales of that digital book title
D_{r,f}=a retailer- and format-specific daily decay rate, which is the rate at which the contribution to a digital book title's WUS by older sales decays over time relative to the contribution of more recent sales to that digital book title's WUS.

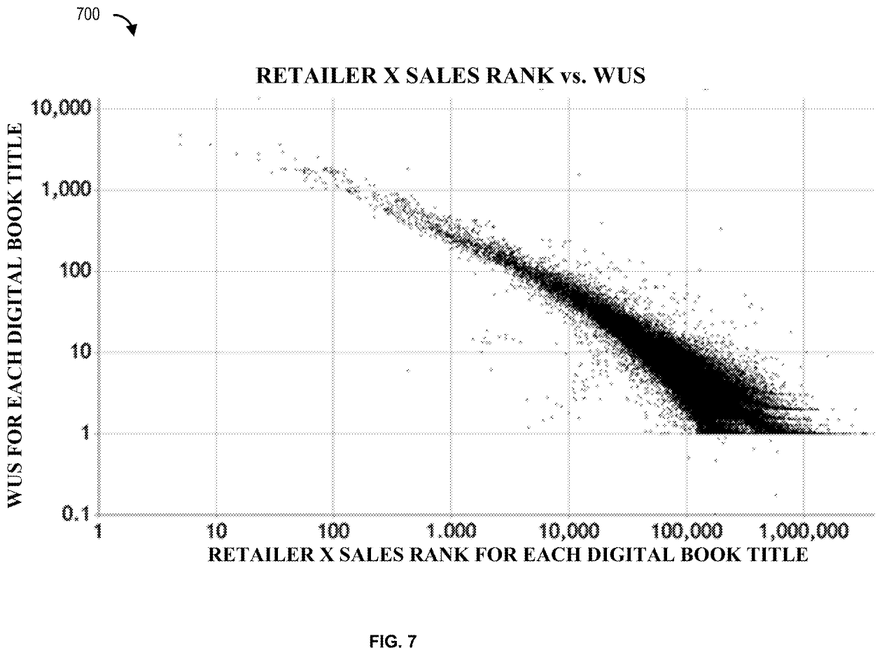

At 208, an optimal curve fit of the sales rank to the weighted unit sales (WUS) amount for each digital book title of the plurality of digital book titles for each retailer of the plurality of retailers may be determined. For example, the determination may be made by the computing device 101 or any other computing device described herein. For example, the optimal curve fit may be an optimal log quadratic curve fit of the sales rank to the weighted unit sales amount. For example, a plurality of periodic (e.g., daily, weekly, monthly, quarterly, etc.) weighted unit sales determined for a plurality (e.g., hundreds, thousands, hundreds of thousands, etc.) of digital book titles from a corresponding true daily title-level sales, as provided by one or more data calibration providers 132 (e.g., a plurality of calibration data partner publishers), may be graphically plotted with the determined sales rank for the digital book title at each retailer for each of plurality of digital book titles during that same period (e.g., day, week, month, calendar quarter, etc.) as shown in the graph 700 of FIG. 7. For example, the graph 700 provides a period-based (e.g., daily, 24 hours, weekly, monthly, quarterly, etc.) scatter-plot that maps Sales Rank to WUS for a particular retailer of the plurality of retailers.

Referring to the graph 700, each dot in the plot corresponds to a single digital book title for a single period (e.g., day, 24 hours, week, month, calendar quarter, etc.), and cross-plots its corresponding weighted unit sales at a given retailer against that digital book title's sales rank at the particular retailer during that period. For example, both axes of the graph 700 may be logarithmic. For example, when displayed in logarithmic form, a roughly quadratic relationship may be observed between WUS and sales rank.

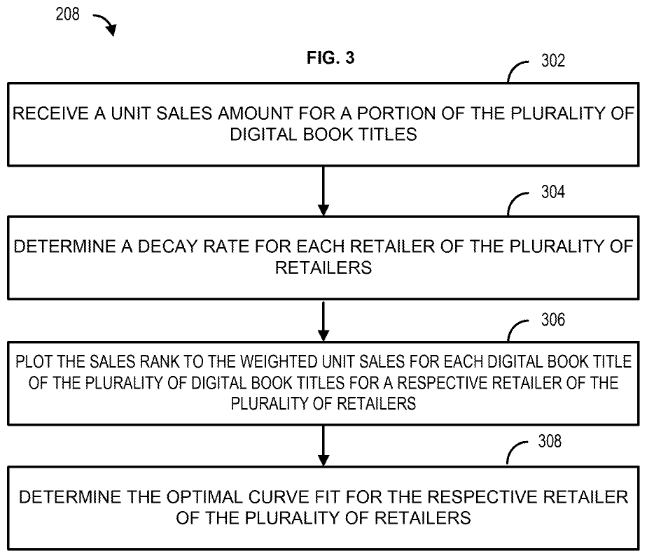

FIG. 3 provides a flowchart of an example method 208 for determining the optimal curve fit. Referring to FIG. 3, at 302, actual unit sales amounts for at least a portion of the plurality of digital book titles may be received. For example, the actual unit sales amounts may be received by the computing device 101 or any other computing device described herein. For example, the actual unit sales amounts for at least the portion of the plurality of digital book titles may be received from one or more (e.g., a plurality of) data calibration providers 132 via the network 140 or another network. For example, the data calibration providers 132 may comprise one or more publishers of digital book titles. The data calibration providers 132 may provide the computing device 101 with a plurality of feeds of title-level daily unit sales actuals for all of their published digital book titles (e.g., e-books, audiobooks, and/or online print book sales).

For example, the actual title-level daily unit sales may not be used in projections of the digital book title sales amount and total period sales value, but instead may be used in determining the decay rate for each retailer of the plurality of retailers. At 304, the decay rate (D_{r,f}) for each retailer and for each digital book format may be determined. For example, the decay rate may be determined by the computing device 101 or any other computing device described herein. For example, the decay rate may be determined based on the title-level daily unit sales actuals. For example, the weighted unit sales may be determined based on the determined decay rate for the particular retailer and digital book format being evaluated.

Methods of determining decay rate could include experimental measurement of impulse responses (decaying ranking over time) over the hours/days following a timed purchase of a title that is otherwise non-selling, or following a timed step-function increase in the purchase rate of a steadily selling title. More generally, the decay rate for a particular retailer may be determined using a group of titles where both true unit sales and sales rankings are known for a multi-day period, and then parametrically varying the decay rate while scatter-plotting each title's weighted unit sales vs sales-rank. Then it can be observed what parametric value of decay rate causes the mathematically smallest overall sum of weighted least-square-errors (and thus the tightest observable “banding” of scatterplot values at different sales-rankings).

At 306, the sales rank to the weighted unit sales for each digital book title of the plurality of digital book titles is plotted on the graph 700 for a respective retailer of the plurality of retailers. For example, a separate graph 700 may be plotted for each respective retailer of the plurality of retailers or for at least a portion of the respective retailers of the plurality of retailers. For example, the sales rank and weighted unit sales for each digital book title may be plotted by the computing device 101 or any other computing device described herein.

At 308, an optimal curve fit for each respective retailer of at least a portion of the plurality of retailers may be determined. For example, the determination may be made by the computing device 101 or any other computing device described herein. For example, the optimal curve fit may be an optimal log quadratic curve fit of the sales rank to the weighted unit sales amount. For example, the algorithmic curve-fit may minimize aggregate or average error in a mathematically optimal way. For a quadratic noisy data-fit, like for the data in the graph 700, convex optimization techniques may provide us with a mathematically optimal curve fit solution based on minimizing the total least-square-error between that curve and the data points themselves. For example, both input and output of the optimization problem may be cast as logarithmic (e.g., the logarithm of sales rank as a quadratic function of the logarithm of WUS). For example casting both the input and output as logarithmic may solve the matrix “conditioning” issues that might otherwise arise due to the many-orders-of-magnitude range of the non-logarithmic WUS and sales rank data, making computed solutions unstable, and may also compress the several-order-of-magnitude range of the non-logarithmic WUS inputs, which if left raw, may cause the solution to skew too far toward outliers, which is undesirable.

For example, for each sales rank grouping or regime (e.g., sales ranks 1-100, sales ranks 100-1,000, sales ranks 1,000-10,000, sales ranks 10,000-100,000, and sales ranks greater than 100,000), convex optimization matrix techniques may be used to determine the optimal corresponding regime-specific parameters x₀, x₁, and x₂ that yield the overall minimum-square-error (MSE) fit across all sales rank and WUS pairings that land in that grouping or regime, in accordance with the following quadratic equation:

$${log}_{10} ( WUS ) = {x}_{0} + {x}_{1} [ {log}_{10} ( S R ) ] + {{x}_{1} ( [ {log}_{10} ( S R ) ] )}^{2}$$

where SR=sales rank
WUS=Weighted Unit Sales

In addition, in order to limit or control discontinuous curve fits when creating the optimal curve fit, the computing device 101 may determine that each pair of adjacent curve-fits must meet each other exactly at the regime boundary between them. For example, at sales rank 100, the WUS determined via the parameterized curve for sales ranks 1-100 must exactly match the WUS determined via the parameterized curve for sales ranks 100-1,000. In addition, at sales rank 10,000 the WUS determined via the parameterized curve for sales ranks 1,000-10,000 must exactly match the WUS determined via the parameterized curve for sales ranks 10,000-100,000.

In addition, in order to limit or control discontinuous curve fits when creating the optimal curve fit, the computing device 101 may determine the slope of each pair of adjacent curve-fits must exactly (or approximately or substantially) match at the regime boundary between them. For example, at sales rank 100, the WUS determined via the parameterized curve for sales rank 1-100 must exactly, approximately, or substantially match the WUS determined via the parameterized curve for sales rank 100-1,000. In addition, at sales rank 10,000 the WUS determined via the parameterized curve for sales ranks 1,000-10,000 must exactly, approximately, or substantially match the WUS determined via the parameterized curve for sales ranks 10,000-100,000.)

As such, in certain example embodiments, it may be preferable to compute a single optimal curve fit solution across all sales rank regimes or groupings at once, that provides distinct parameters x₀, x₁, and x₂ for each sales rank regime or grouping's curve that together in combination yield the lowest sum-total overall mean-squared error (MSE) across all sales rank regimes or groupings, while meeting cleanly at the sales rank regime or grouping boundaries. Accordingly, recasting the above constrained convex optimization problem into matrix form, provides the following: minimize ∥Ax−b∥2, subject to Cx=d,
where m is the number of sales rank breakpoints (e.g., sales rank=100, 1000, 10000, etc.) defined to separate the curve into m+1 different sales rank regimes or groupings for which distinct regime-specific log-quadratic curve-fit parameters are generated.
n is the total count of WUS/sales rank data pairs to be curve-fitted, while n₀, n₁, n₂, . . . , nₘ are the counts of WUS/sales rank data pairs that fall into each sales rank regime or grouping defined above (where, n=n₀+n₁+n₂+ . . . +nₘ)
A is a n×3m input matrix, populated as defined below
b is a 3m×1 input matrix (vector), populated as defined below
C is a 2m×3m input constraint matrix, populated as defined below
d is a 2m×1 matrix (vector) of zeroes, as defined below
x is the 3m×1 solution matrix (vector) which will contain the optimal curve-fit parameters for each regime or grouping, laid out as defined below

$$A = [ \begin{matrix}1 & {log}_{10} ( {SR}_{0 , 1} ) & {[ {log}_{10} ( {SR}_{0 , 1} ) ]}^{2} & 0 & 0 & 0 & 0 & 0 & 0 & … & 0 & 0 & 0 \\ 1 & {log}_{10} ( {SR}_{0 , 2} ) & {[ {log}_{10} ( {SR}_{0 , 2} ) ]}^{2} & 0 & 0 & 0 & 0 & 0 & 0 & … & 0 & 0 & 0 \\ ⋮ & ⋮ & ⋮ & ⋮ & ⋮ & ⋮ & ⋮ & ⋮ & ⋮ & ⋱ & ⋮ & ⋮ & ⋮ \\ 1 & {log}_{10} ( {SR}_{0 , {n}_{0}} ) & {[ {log}_{10} ( {SR}_{0 , {n}_{0}} ) ]}^{2} & 0 & 0 & 0 & 0 & 0 & 0 & … & 0 & 0 & 0 \\ 0 & 0 & 0 & 1 & {log}_{10} ( {SR}_{1 , 1} ) & {[ {log}_{10} ( {SR}_{1 , 1} ) ]}^{2} & 0 & 0 & 0 & … & 0 & 0 & 0 \\ 0 & 0 & 0 & 1 & {log}_{10} ( {SR}_{1 , 2} ) & {[ {log}_{10} ( {SR}_{1 , 2} ) ]}^{2} & 0 & 0 & 0 & … & 0 & 0 & 0 \\ ⋮ & ⋮ & ⋮ & ⋮ & ⋮ & ⋮ & ⋮ & ⋮ & ⋮ & ⋱ & ⋮ & ⋮ & ⋮ \\ 0 & 0 & 0 & 1 & {log}_{10} ( {SR}_{1 , {n}_{1}} ) & {[ {log}_{10} ( {SR}_{1 , {n}_{1}} ) ]}^{2} & 0 & 0 & 0 & … & 0 & 0 & 0 \\ 0 & 0 & 0 & 0 & 0 & 0 & 1 & {log}_{10} ( {SR}_{2 , 1} ) & {[ {log}_{10} ( {SR}_{2 , 1} ) ]}^{2} & … & 0 & 0 & 0 \\ 0 & 0 & 0 & 0 & 0 & 0 & 1 & {log}_{10} ( {SR}_{2 , 2} ) & {[ {log}_{10} ( {SR}_{2 , 2} ) ]}^{2} & … & 0 & 0 & 0 \\ ⋮ & ⋮ & ⋮ & ⋮ & ⋮ & ⋮ & ⋮ & ⋮ & ⋮ & ⋱ & ⋮ & ⋮ & ⋮ \\ 0 & 0 & 0 & 0 & 0 & 0 & 1 & {log}_{10} ( {SR}_{2 , {n}_{2}} ) & {[ {log}_{10} ( {SR}_{2 , {n}_{2}} ) ]}^{2} & … & 0 & 0 & 0 \\ ⋮ & ⋮ & ⋮ & ⋮ & ⋮ & ⋮ & ⋮ & ⋮ & ⋮ & ⋱ & ⋮ & ⋮ & ⋮ \\ 0 & 0 & 0 & 0 & 0 & 0 & 0 & 0 & 0 & … & 1 & {log}_{10} ( {SR}_{m , 1} ) & {[ {log}_{10} ( {SR}_{m , 1} ) ]}^{2} \\ 0 & 0 & 0 & 0 & 0 & 0 & 0 & 0 & 0 & … & 1 & {log}_{10} ( {SR}_{m , 2} ) & {[ {log}_{10} ( {SR}_{m , 2} ) ]}^{2} \\ ⋮ & ⋮ & ⋮ & ⋮ & ⋮ & ⋮ & ⋮ & ⋮ & ⋮ & ⋱ & ⋮ & ⋮ & ⋮ \\ 0 & 0 & 0 & 0 & 0 & 0 & 0 & 0 & 0 & … & 1 & {log}_{10} ( {SR}_{m , {n}_{m}} ) & {[ {log}_{10} ( {SR}_{m , {n}_{m}} ) ]}^{2}\end{matrix} ]$$

$$b = [ \begin{matrix}{WUS}_{0 , 1} \\ {WUS}_{0 , 2} \\ ⋮ \\ {WUS}_{0 , {n}_{0}} \\ {WUS}_{1 , 1} \\ {WUS}_{1 , 2} \\ ⋮ \\ {WUS}_{1 , {n}_{1}} \\ {WUS}_{2 , 1} \\ {WUS}_{2 , 2} \\ ⋮ \\ {WUS}_{2 , {n}_{2}} \\ ⋮ \\ {WUS}_{m , 1} \\ {WUS}_{m , 2} \\ ⋮ \\ {WUS}_{m , {n}_{m}}\end{matrix} ]$$

$$C = [ \begin{matrix}\text{?} & \text{?} & \text{?} & \text{?} & \text{?} & \text{?} & \text{?} & \text{?} & \text{?} & \text{?} & \text{?} & \text{?} & \text{?} & \text{?} & \text{?} \\ \text{?} & \text{?} & \text{?} & \text{?} & \text{?} & \text{?} & \text{?} & \text{?} & \text{?} & \text{?} & \text{?} & \text{?} & \text{?} & \text{?} & \text{?} \\ \text{?} & \text{?} & \text{?} & \text{?} & \text{?} & \text{?} & \text{?} & \text{?} & \text{?} & \text{?} & \text{?} & \text{?} & \text{?} & \text{?} & \text{?} \\ \text{?} & \text{?} & \text{?} & \text{?} & \text{?} & \text{?} & \text{?} & \text{?} & \text{?} & \text{?} & \text{?} & \text{?} & \text{?} & \text{?} & \text{?} \\ \text{?} & \text{?} & \text{?} & \text{?} & \text{?} & \text{?} & \text{?} & \text{?} & \text{?} & \text{?} & \text{?} & \text{?} & \text{?} & \text{?} & \text{?} \\ \text{?} & \text{?} & \text{?} & \text{?} & \text{?} & \text{?} & \text{?} & \text{?} & \text{?} & \text{?} & \text{?} & \text{?} & \text{?} & \text{?} & \text{?} \\ \text{?} & \text{?} & \text{?} & \text{?} & \text{?} & \text{?} & \text{?} & \text{?} & \text{?} & \text{?} & \text{?} & \text{?} & \text{?} & \text{?} & \text{?}\end{matrix} \text{?}$$

$$D = [ \begin{matrix}0 \\ 0 \\ 0 \\ 0 \\ ⋮ \\ 0 \\ 0\end{matrix} ]$$

$$x = [ \begin{matrix}{x}_{0 , 0} \\ {x}_{0 , 1} \\ {x}_{0 , 2} \\ {x}_{1 , 0} \\ {x}_{1 , 1} \\ {x}_{1 , 2} \\ {x}_{2 , 0} \\ {x}_{2 , 1} \\ {x}_{2 , 2} \\ ⋮ \\ {x}_{m , 0} \\ {x}_{m , 1} \\ {x}_{m , 2}\end{matrix} ]$$

$$\text{?} \text{indicates text missing or illegible when filed}$$

where SR_{y,z}=the sales rank of data point z within regime y (i.e. having a SalesRank lying between breakpoint y−1 and y)
WUS_{y,z}=the WUS of data point z within regime y (i.e. having a sales rank lying between breakpoint y−1 and y)
SR_{bpy}=the sales rank at breakpoint x (i.e. breakpoint separating regimes y and y+1)
x_{y,0}=the constant-term parameter for the optimal constrained curve-fit for regime y
x_{y,1}=the linear-term parameter for the optimal constrained curve-fit for regime y
x_{y,2}=the quadratic-term parameter for the optimal constrained curve-fit for regime y

To determine a solution of a constrained least squares problem laid out as above, the computing device 101 may, for example, form the Lagrangian function, which, for example, may at the optimum solution point have zero slope in every direction. As such, the Karush-Kuhn-Tucker (KKT) conditions dictate that, for optimality, the matrices above may satisfy the condition:

$$[ \begin{matrix}2 {A}^{T} A & {C}^{T} \\ C & 0\end{matrix} ] [ \begin{matrix}\hat{x} \\ z\end{matrix} ] = [ \begin{matrix}2 {A}^{T} b \\ d\end{matrix} ]$$

where \hat{x} is the optimal solution vector of curve-fit parameters x, and z is the vector of Lagrange multipliers. For example, the computing device 101 may invert the KKT matrix above to obtain the optimal solution to \hat{x} via:

$$[ \begin{matrix}\hat{x} \\ z\end{matrix} ] = {[ \begin{matrix}2 {A}^{T} A & {C}^{T} \\ C & 0\end{matrix} ]}^{- 1} [ \begin{matrix}2 {A}^{T} b \\ d\end{matrix} ] .$$

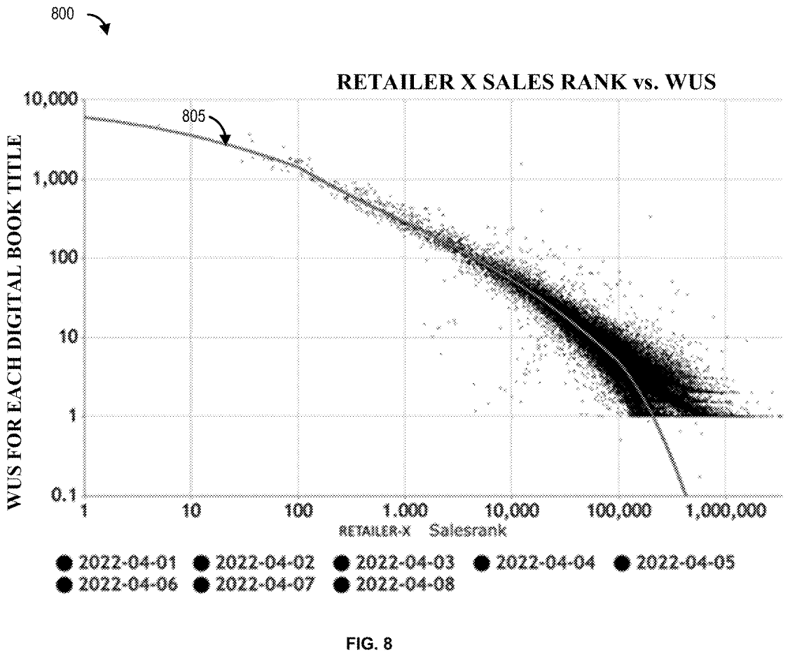

For example, the computing device 101 may determine the optimal curve fit by running multiple iterative passes of the above matrix computation, and may, each time, exclude from the next computation individual data points that lie further than a first threshold factor (e.g., 1.5×) above and/or a second threshold factor (e.g., 0.5×) below the previous iteration's determined curve. While the example above uses 1.5× for the first threshold factor and 0.5× for the second threshold factor, in other examples, the threshold factors can be any number between 0.001-20). This may be done until the solution fully converges (e.g., there are no more outliers left or the number of outliers is below a threshold amount) or a pre-set maximum iteration count is reached. FIG. 8 shows an example graph 800 showing the optimal curve fit 805 based on the plotting of the graph 700 of data shown in FIG. 7. For example, the optimal curve fit may yield the following formulas for determining the period unit sales amount for each digital book of the plurality of digital books at the respective retailer within each regime or grouping:

$$Sales rank 1 - 100 : {log}_{10} ( WUS ) = 3.7039683510027652 - 0.1383533968917675 [ {log}_{10} ( SR ) ] - 0.08741441645870618 {( [ {log}_{10} ( SR ) ] )}^{2}$$

$$Sales rank 101 - 1 , 000 : {log}_{10} ( WUS ) = 4.934152964469581 - 1.0860241942268942 [ {log}_{10} ( SR ) ] + 0.07887482884125951 {( [ {log}_{10} ( SR ) ] )}^{2}$$

$$Sales rank 1 , 001 - 10 , 000 : {log}_{10} ( WUS ) = 3.7067352897607915 - 0.22312486349889582 [ {log}_{10} ( SR ) ] + 0.07237853976532449 {( [ {log}_{10} ( SR ) ] )}^{2}$$

$$Sales rank 10 , 000 - 100 , 000 : {log}_{10} ( WUS ) = 1.861352933842175 - 0.7359702687463141 [ {log}_{10} ( SR ) ] - 0.19681592558441707 {( [ {log}_{10} ( SR ) ] )}^{2}$$

$$Sales rank >= 100 , 001 : {log}_{10} ( WUS ) = - 34.41694386203669 + 15.6187 [ {log}_{10} ( SR ) ] - 1.72223 {( [ {log}_{10} ( SR ) ] )}^{2}$$

Those of ordinary skill in the art will recognize that the above formulas for the sales rank regimes or groupings are an example only and determined based on example sales rank and WUS data for a retailer. The formulas for other retailers, determined based on optimal curve fit would likely be different and vary from retailer to retailer.

At 210, a period unit sales amount may be determined for each digital book title for the plurality of retailers. For example, the determination may be made by the computing device 101 or any other computing device described herein. For example, the period unit sales amount may represent the estimated unit sales amount for the digital book title during the period (e.g., day, 24 hours, week, month, calendar quarter, year, etc.). For example, the period unit sales amount for the digital book title may be determined for each retailer of the plurality of retailers and then summed together to get the period unit sales about for the digital book title for the plurality of retailers. For example, the period unit sales amount for each digital book title may be determined based on the sales rank for the particular digital book title. For example, the period unit sales amount for each digital book title may be determined based on the sales rank for the particular digital book title and the digital book format for the particular digital book title.

For example, on a periodic (e.g., nightly, daily, weekly, monthly, quarterly, etc.) basis, the computing device 101 may compute period unit sales amount and total period sales value at the digital book title level for each e-book, audiobook, and printed-book sold online at each retailer tracked as described above. For example, the period unit sales amount may be determined by determining the current WUS for each digital book title from its sales rank captured during the period using the most up-to-date calibrated optimal curve-fit for the particular retailer, as follows:

$${WUS}_{current} = 1 {0}^{( {x}_{0} + {x}_{1} [ {log}_{10} ( S {R}_{current} ) ] + {{x}_{2} ( [ {log}_{10} ( S {R}_{current} ) ] )}^{2} )}$$

where SR_{current}=the current sales rank (e.g., today's latest captured sales rank) for a given digital book title
X₀, X₁, and X₂=the most up-to-date constant, linear, and quadratic parameters computed for the book's retailer, format, and the sales rank regime that SR_{current} lies within
WUS_{current}=the current computed WUS for that book title
   Then, for each book, its period unit sales amount may be determined by attenuating the previous WUS value stored for that digital book title yesterday, and subtracting it from the current WUS to yield the book title's period unit sales amount:

$$Period Unit Sales Amount = {WUS}_{current} - ( {[ \frac{1}{{D}_{r , f}} ]}^{( {t}_{c urrent} - {t}_{previous} )} {WUS}_{previous} )$$

where t_{current}=today's timestamp (today's last sales rank captured for a digital book title)
tₚᵣₑᵥᵢₒᵤₛ=yesterday's (or prior) timestamp (corresponding to timestamp of sales rank from which previous WUS was determined for that digital book title)
WUS_{current}=today's determined WUS for the digital book title
WUSₚᵣₑᵥᵢₒᵤₛ=previous WUS determined for that book title
D_{r,f}=the retailer- and format-specific daily (or hourly) decay rate, which is the rate at which the contribution to a digital book title's WUS by older sales decays over time relative to the contribution of more recent sales to that digital book title's WUS.

In addition, the computing device 101 may determine a sales price for each particular digital book title of the plurality of digital book titles and each available digital book format for the respective digital book title. For example, the sales price may be determined from the plurality of digital book data received or retrieved from the book retailer websites 160A-C. For example, the sales price may be the same for each digital book format or may be different for one or more of the digital book formats for a respective digital book title. The computing device 101 may determine a period sales value for each respective digital book title at each respective retailer of the plurality of retailers. For example, the period sales value may be determined based on the sales price for each respective digital book title and format for each respective retailer of the plurality of retailers and the period sales of each digital book title in the particular format for each respective retailer. For example, the period sales value for a particular format of a digital book title may be determined by multiplying the period sales for the particular format of the digital book title at a retailer by the sales price for that digital book title in that format at that retailer. The period sales value for the digital book title may further be determined by summing the period sales value for each particular format of the digital book title at that retailer.

The computing device 101 may further determine the total period sales value for each respective digital book title of the plurality of digital book titles. For example, determining the total period sales value may be based on the period sales value for the particular respective book title of the plurality of digital book titles at each retailer of the plurality of retailers. For example, the computing device 101 may take the sum of all of the period sales values at all of the plurality of retailers that have sold the particular digital book title during the period to result in the total period sales value. The computing device 101 may create and or retrieve a record associated with the digital book title and add the total period sales value for the particular period into the record. The computing device 101 may further add or include in the record, the digital book metadata for the particular digital book title received or retrieved from the plurality of digital book data.

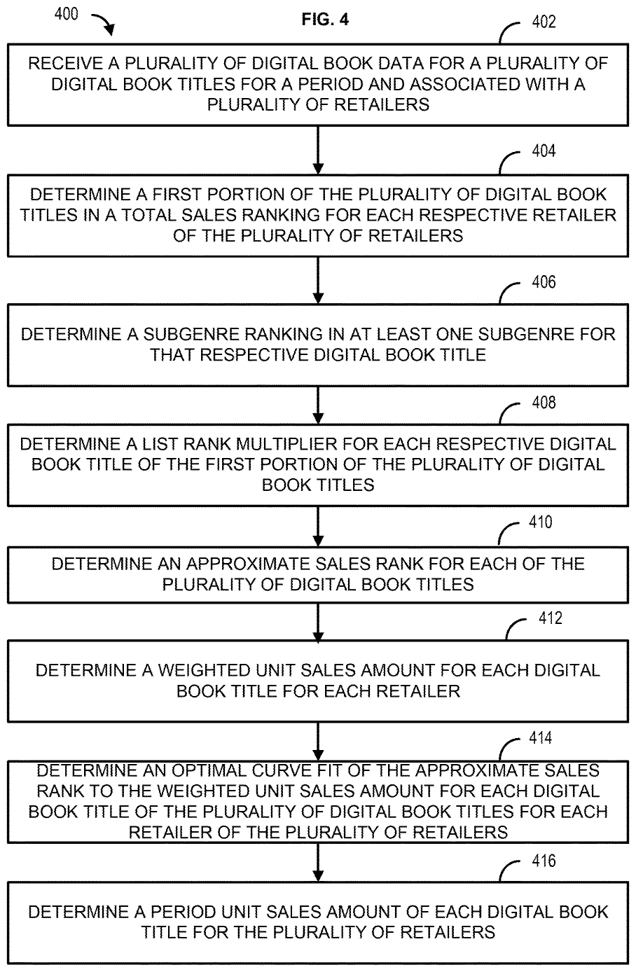

FIG. 4 shows a flowchart of an example method 400 for determining digital book sales at a book title-level basis and/or a digital book format basis for a given market. For example, the method 400 may be completed by the computing device 101 or any other computing device described herein. For example, the market may be a country, a group of countries, a region, or the like. For example, a digital book may be any kind of book sold via an electronic network or the Internet (e.g., via a website). This may include print books (e.g., physical hard-back or paperback books) sold via the electronic network or the internet. For example, a digital book format may be one or more of an electronic book (or e-book), an audio book, or a print book.

At 402, a plurality of digital book data for a plurality of digital book titles for a period of time may be received or retrieved. For example, the plurality of digital book data may be received by the computing device 101 or any other computing device described herein. For example, the plurality of digital book data may be received or retrieved from one or more (e.g., a plurality) of digital book retailer websites 160A-C. For example, the period of time or time period may be a day, 24 hours, a week, a month, a year, or a quarter of a calendar year. For example, the plurality of digital book data may comprise digital book title-level metadata. For example, the plurality of digital book data (e.g., the digital book title-level metadata) may comprise one or more of a sales price, a list price, a total sales ranking, a genre sales ranking, or a subgenre sales ranking.

For example, the plurality of digital book data for the plurality of digital book titles may include raw data collected to be able compute market-wide digital book sales. For example, the plurality of digital book data may include millions of webpages captured on a periodic (e.g., daily, 24 hour, weekly, monthly, quarterly) basis from digital (e.g., online) book retailers. For example, the plurality of digital book data may comprise a plurality (e.g., tens of thousands) of genre-specific retailer bestseller lists with relative sales rankings for digital books in each or a particular book format (e.g., e-book, audiobook, and print books) in those genres, such as, but not limited to, Top 100 Cozy Mysteries, Top 100 Biographies of Sports Leaders, Top 100 Teen & Young Adult Urban Fantasy Novels, etc.

For example, the plurality of digital book data may comprise a plurality (e.g., thousands, millions, or more) of retailer “product description” webpages for specific e-books, audiobooks, and print books that the one or more computing devices discover on the above bestseller lists, as “also-boughts” associated with other books (e.g., “readers who bought this book also bought these other books . . . ”) or which are determined herein to be likely nonzero-sellers that period due to having nonzero sales over the previous seven days. For example, the product-description webpages may contain relevant digital book metadata. For example, the digital book metadata may comprise one or more of the title, author, publisher label, publication date, retailer stock keeping unit (SKU), international standard book number (ISBN), and/or narrator (for audiobooks). These pages and the digital book metadata may also contain sale price for the digital book in the particular format, list price for the digital book in the particular format, and (for some retailers) an total sales ranking for that digital book out of all the digital books of that format (e.g., e-book, audiobook, print book, etc.) sold at that retailer. For example, the plurality of digital book data may comprise a plurality of ISBN cross-lookups of digital books found at one retailer to discover their equivalent SKUs, data, and sales at other retailers. For example, the plurality of digital book data may comprise a plurality of book cover-image matching scores (via machine-learning analysis) for pairs of non-ISBN-bearing book SKUs at different retailers that fuzzy metadata matching, using machine-learning method disclosed herein, indicates are likely to be different-retailer editions of the same digital book title.

Many digital (e.g., online) retailers 160A-C may have sophisticated “bot blockers” and active countermeasures in place (like CAPTCHAs) to attempt to block programmatic web-scraping-based data collection at scale. The architecture of the systems and methods disclosed herein is designed to counter these mechanisms with a combination of robust and redundant collection strategies, a fleet of high-powered data scrapers 130A-C, aggressive brute force retry strategies (which may average many hundreds of millions of page requests per period (e.g., day)), and the routing of all automated webpage HTTP requests through hundreds of thousands of disparate IP addresses within each market or portion of the market (e.g., city, state, country, or group of countries) to be evaluated and for which digital book data will be collected.

The pluggable proxy architecture of the systems and methods disclosed herein allow for use of an interchangeable selection of different proxy vendors to provide the hundreds of thousands of country-specific proxy IP addresses through which the plurality of digital book data is retrieved or received on a periodic (e.g., daily, 24 hour, weekly, monthly, quarterly, etc.) basis, such as millions of pages of HTML digital book rankings and book product pages from retailer websites. At any given time, up to 3 or more different proxy-IP vendors per market may be used to ensure no single points of failure and to provide built-in automated failover/redundancy as each individual proxy vendor's effectiveness (capture efficiency at evading bot-blockers, total network/page capture rate/throughput, and price/performance ratio) varies independently over time.

For each retailer and digital book format sold at each retailer, the systems and methods disclosed herein may determine, to within precise statistical limits, the shape of the “long tail” of that distribution, and therefore, roughly what overall sales ranking may correspond to zero sales in the last period (e.g., last day, 24 hours, week, month, quarter, etc.). The systems and methods disclosed herein may use this information to “steer” the collection process throughout the period reactively and in real-time, to increase the possibility that the digital book sales data captures data on all digital books selling at least one copy during the particular period, while capturing data on as few digital books that had zero sales during the period.

In certain examples, some digital book retailers do not have total sales ranks for all of the digital book titles that it sells that are publicly visible on the product description webpage for each respective digital book title that the digital book retailer sells. For example, some digital book retailers only make publicly available an Overall Top-100 List or Overall Top-200 List (e.g., Overall Top-X List) thereby only making publicly accessible a total sales rank for a portion of the plurality of digital book titles that the retailer actually sells. In examples where one or more retailers of the plurality of retailers only provides total sales rank for a portion of the digital book titles that it sells, the computing device 101, or any other computing device described herein may determine an estimated or approximate total sales rank for all of the remaining portion of digital book titles for which the retailer does not provide an actual total sales rank.

At 404, a first portion of the plurality of digital book titles in a total sales ranking for the respective retailer of the plurality of retailers may be determined. For example, when the retailer only provides and Overall Top 100 total sales rank list for the period, it is these 100 digital book titles that will make up the first portion of the plurality of digital book titles as these are the only digital book titles for that particular retailer for which a publicly available total sales rank for the period is provided. For example, the determination may be made by the computing device 101 or any other computing devices described herein. For example, the first portion of the plurality of digital book titles for the particular retailer may be determined based on the plurality of digital book data.

At 406, for each respective digital book title of the first portion of the plurality of digital book titles, at least one subgenre ranking in at least one subgenre associated with the particular digital book title may be determined for that period (e.g., day, 24 hours, week, month, calendar quarter, etc.). For example, the determination may be made by the computing device 101 or any other computing device described herein. For example, a digital book title may be associated with one or more subgenres. For example, a digital book title may be associated with a subgenre when the digital book title is classified as belonging to or being within that particular subgenre. For example, for every digital book title appearing in the total sales rank for the retailer (e.g., the first portion of the plurality of digital book titles), and therefore having a known total sales rank, the computing device 101 may search for and each of those respective digital book titles of the first portion of the plurality of book titles on all of the particular retailer's subgenre rankings lists for that period. For example, a particular digital book title of the first portion of the plurality of digital book titles may have one or more than one identifiable subgenre ranking (e.g., the digital book title may be classified in multiple subgenres and listed in the subgenre ranking for each or a portion of those subgenres. The computing device 101 may then identify and/or record the one or more subgenre rankings for each particular digital book title in the first portion of the plurality of digital book titles.

At 408, a list rank multiplier may be determined for each subgenre rankings list for the particular retailer of the plurality of retailers. For example, the list rank multiplier may be determined by the computing device 101 or any other computing device described herein. For example, the list rank multiplier may be determined based on the one or more subgenre rankings for the particular digital book title of the first portion of the plurality of digital book titles. For example, the list rank multiplier may be determined based on the following:

$${ListRankMultiplier}_{subgenre , k} = \frac{{SalesRank}_{k}}{{ListRank}_{subgenre , k}}$$

where SalesRankₖ=the total sales rank of book k found on the Overall Top-X List
ListRank_{subgenre,k}=the relative subgenre rank of book k on the subgenre-specific ranking list
ListRankMultiplier_{subgenre,k}=a candidate list rank multiplier for the particular subgenre that can convert relative subgenre rank from that subgenre-specific ranking list to an overall approximate sales rank (out of all digital book titles sold by the retailer)

For example, The list rank multiplier candidates determined for each subgenre where Overall Top-X List books appear may then be averaged, to generate a mean list rank multiplier for that specific subgenre:

$${ListRankMultiplier}_{subgenre} = \frac{1}{n} ( {\sum }_{k = 0}^{n} {ListRankMultiplier}_{subgenre , k} )$$

where ListRankMultiplier_{subgenre,k}=candidate list rank multiplier k found for the subgenre-specific ranking list
n=the total number of candidate multipliers found for the subgenre-specific ranking list
ListRankMultiplier_{subgenre}=the final list rank multiplier used to convert ListRank from that subgenre-specific ranking list to an overall approximate total sales rank (out of all digital book titles for the retailer)

At 410, an approximate total sales rank for each of the plurality of digital book titles sold by the particular retailer of the plurality of retailers may be determined. For example, the approximate total sales rank may be determined by the computing device 101 or any other computing device described herein. For example, the approximate total sales rank may be determined based on the list rank multiplier for one or more of the subgenres associated with the particular digital book title for which the approximate total sales rank is being determined at that time. For example, an approximate total sales rank may be determined for all other digital book titles in each of the subgenre rankings for the retailer that were not included in the first portion of the plurality of digital book titles that were already provided in a total rankings list for that retailer (e.g., Overall Top X List). For example, the computing device 101 may determine the approximate total sales rank for all of the other digital book titles as follows:

$${ApproximateSalesRank}_{k} = {ListRankMultiplier}_{subgenre} * {ListRank}_{subgenre , k}$$

where ListRankMultiplier_{subgenre}=the final list rank multiplier used to convert ListRank from that subgenre-specific ranking list to an ApproximateSalesRank (out of all books)
ListRank_{subgenre,k}=the relative ListRank of book k on the subgenre-specific bestseller List
ApproximateSalesRankₖ=a projected overall approximate total sales rank for book title k.

For example, elements 408-410 may be repeating iteratively using approximate total sales rank rather than actual total sales rank to assign final list rank multipliers to other subgenre-specific ranking lists that did not include any digital book titles included in the first portion of the plurality of digital book titles provided in a total rankings list for that retailer.

At 412, a weighted unit sales amount for each digital book title of the plurality of digital book titles for each retailer of the plurality of retailers may be determined. For example, the determination may be made by the computing device 101 or any other computing device described herein. For example, the parameterized form of weighted unit sales for each digital book title may be quite consistent across different retailers and digital book formats, with only the specific numerical parameters varying by retailer (and more rarely, by format within a retailer). For example, the weighted unit sales (WUS) for a given retailer (r) and digital book format (f) may be calculated for each specific digital book title as:

$${WUS}_{r , f} = {\sum }_{n = 0}^{- ∞} {{s}_{n} [ \frac{1}{{D}_{r , f}} ]}^{{t}_{n}}$$

where t₁=a particular past time period (for example, t₀=today, t₋₁=yesterday, ₜ₋₂=the day before yesterday, etc.—although hours may be substituted for days in certain example embodiments for more accuracy)
sₙ=the number of unit sales of that digital book title occurring at time tₙ (or more precisely, the number of unit sales of that digital book title occurring between time tₙ₋₁ and tₙ)
D_{r,f}=a retailer- and format-specific daily (or hourly) decay rate, which is the rate at which the contribution to a digital book title's WUS by older sales decays over time relative to the contribution of more recent sales to that digital book title's WUS

For example, with weighted unit sales determined in this form, for a retailer of the plurality of retailer, the process need only record the latest value of WUS computed for each digital book title, and then update it over time incrementally to incorporate newer sales (or even in the absence of new sales) using, for example, the following:

$${WUS}_{{t}_{n + 1}} = ( {[ \frac{1}{{D}_{r , f}} ]}^{( {t}_{n + 1} - {t}_{n} )} {WUS}_{{t}_{n}} ) + {s}_{n + 1}$$

where tₙ₊₁=the current time period
t₀=the previous time period
WUSₜ_{ₙ}=the previously computed WUS value for tₙ
WUSₜ_{ₙ₊₁}=the updated WUS value at tₙ₊₁
ₛ_{ₙ₊₁}=the number of unit sales of that digital book title occurring between time tₙ and tₙ₊₁
D_{r,f}=the retailer- and format-specific daily (or hourly) decay rate, which is the rate at which the contribution to a digital book title's WUS by older sales decays over time relative to the contribution of more recent sales to that digital book title's WUS.

For example, when the daily sales cadence for a digital book title is uniformly or substantially uniformly consistent (e.g., always or usually X sales per day) or even approximately consistent, the determination of weighted unit sales for a digital book title at a particular retailer of the plurality of retailers becomes:

$${WUS}_{r , f} = {s}_{d} ( \frac{1}{1 - {D}_{r , f}} )$$

where WUS_{r,f}=the steady-state WUS value for the digital book title
WUSₜ_{ₙ₊₁}=the updated WUS value at tₙ₊₁
s_{d}=the uniform or substantially uniform number of daily unit sales of that digital book title
D_{r,f}=a retailer- and format-specific daily decay rate, which is the rate at which the contribution to a digital book title's WUS by older sales decays over time relative to the contribution of more recent sales to that digital book title's WUS.

At 414, an optimal curve fit of the approximate total sales rank to the weighted unit sales (WUS) amount for each digital book title of the plurality of digital book titles for each retailer of the plurality of retailers may be determined. For example, the determination may be made by the computing device 101 or any other computing device described herein. For example, the optimal curve fit may be an optimal log quadratic curve fit of the approximate total sales rank to the weighted unit sales amount. For example, a plurality of periodic (e.g., daily, weekly, monthly, quarterly, etc.) weighted unit sales determined for a plurality (e.g., hundreds, thousands, hundreds of thousands, etc.) of digital book titles from a corresponding true daily title-level sales, as provided by one or more data calibration providers 132 (e.g., a plurality of calibration data partner publishers), may be graphically plotted with the determined approximate total sales rank for the digital book title at each retailer for each of plurality of digital book titles during that same period (e.g., day, week, month, calendar quarter, etc.) in substantially the same manner as that shown in the graph 700 of FIG. 7 except that approximate total sales rank may replace the total sales rank of the graph 700.

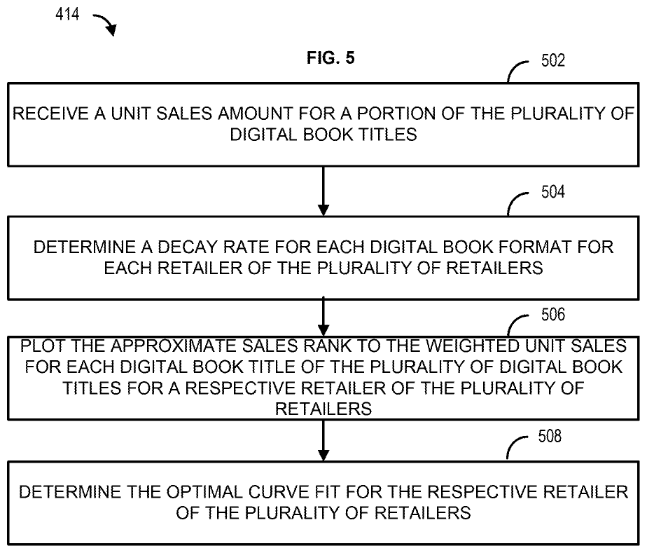

FIG. 5 provides a flowchart of an example method 414 for determining the optimal curve fit. Referring to FIG. 5, at 502, actual unit sales amounts for at least a portion of the plurality of digital book titles may be received. For example, the actual unit sales amounts may be received by the computing device 101 or any other computing device described herein. For example, the actual unit sales amounts for at least the portion of the plurality of digital book titles may be received from one or more (e.g., a plurality of) data calibration providers 132 via the network 140 or another network. For example, the data calibration providers 132 may comprise one or more publishers of digital book titles. The data calibration providers 132 may provide the computing device 101 with a plurality of feeds of title-level daily unit sales actuals for all of their published digital book titles (e.g., e-books, audiobooks, and/or online print book sales).

For example, the actual title-level daily unit sales may not be used in projections of the digital book title sales amount and total period sales value, but instead may be used in determining the decay rate for each retailer of the plurality of retailers. At 504, the decay rate (D_{r,f}) for each retailer and for each digital book format may be determined. For example, the decay rate may be determined by the computing device 101 or any other computing device described herein. For example, the decay rate may be determined based on the title-level daily unit sales actuals. For example, the weighted unit sales may be determined based on the determined decay rate for the particular retailer and digital book format being evaluated.

For example, determining the decay rate could include experimental measurement of impulse responses (decaying ranking over time) over the hours/days following a timed purchase of a title that is otherwise non-selling, or following a timed step-function increase in the purchase rate of a steadily selling title. More generally, the decay rate for a particular retailer may be determined using a group of titles where both true unit sales and sales rankings are known for a multi-day period, and then parametrically varying the decay rate while scatter-plotting each title's weighted unit sales vs sales-rank. Then it can be observed what parametric value of decay rate causes the mathematically smallest overall sum of weighted least-square-errors (and thus the tightest observable “banding” of scatterplot values at different sales-rankings).

At 506, the approximate total sales rank to the weighted unit sales for each digital book title of the plurality of digital book titles is plotted in a manner substantially the same as that shown on the graph 700 for a respective retailer of the plurality of retailers. For example, a separate graph 700 may be plotted for each respective retailer of the plurality of retailers or for at least a portion of the respective retailers of the plurality of retailers. For example, the approximate total sales rank and weighted unit sales for each digital book title may be plotted by the computing device 101 or any other computing device described herein.

At 508, an optimal curve fit for each respective retailer of at least a portion of the plurality of retailers may be determined. For example, the determination may be made by the computing device 101 or any other computing device described herein. For example, the optimal curve fit may be an optimal log quadratic curve fit of the approximate total sales rank to the weighted unit sales amount for the plurality of digital book titles sold by the retailer during the period. For example, both input and output of the optimization problem may be cast as logarithmic (e.g., the logarithm of sales rank as a quadratic function of the logarithm of WUS).

For example, for each approximate total sales rank grouping or regime (e.g., approximate total sales ranks 1-100, approximate total sales ranks 100-1,000, approximate total sales ranks 1,000-10,000, approximate total sales ranks 10,000-100,000, and approximate total sales ranks greater than 100,000), convex optimization matrix techniques may be used to determine the optimal corresponding regime-specific parameters x₀, x₁, and x₂ that yield the overall minimum-square-error (MSE) fit across all approximate total sales rank and WUS pairings that land in that grouping or regime, in accordance with the following quadratic equation:

$$l o {g}_{10} ( WUS ) = {x}_{0} + {x}_{1} [ {log}_{10} ( S R ) ] + {{x}_{1} ( [ {log}_{10} ( S R ) ] )}^{2}$$

where SR=approximate total sales rank
WUS=Weighted Unit Sales

In addition, in order to limit or control discontinuous curve fits when creating the optimal curve fit, the computing device 101 may determine that each pair of adjacent curve-fits must meet each other exactly at the regime boundary between them. For example, at approximate total sales rank 100, the WUS determined via the parameterized curve for approximate total sales ranks 1-100 must exactly match the WUS determined via the parameterized curve for approximate total sales ranks 100-1,000. In addition, at approximate total sales rank 10,000 the WUS determined via the parameterized curve for approximate total sales ranks 1,000-10,000 must exactly match the WUS determined via the parameterized curve for approximate total sales ranks 10,000-100,000.

In addition, in order to limit or control discontinuous curve fits when creating the optimal curve fit, the computing device 101 may determine the slope of each pair of adjacent curve-fits must exactly (or approximately or substantially) match at the regime boundary between them. For example, at approximate total sales rank 100, the WUS determined via the parameterized curve for approximate total sales rank 1-100 must exactly, approximately, or substantially match the WUS determined via the parameterized curve for approximate total sales rank 100-1,000. In addition, at approximate total sales rank 10,000 the WUS determined via the parameterized curve for approximate total sales ranks 1,000-10,000 must exactly, approximately, or substantially match the WUS determined via the parameterized curve for approximate total sales ranks 10,000-100,000.)

As such, in certain example embodiments, it may be preferable to compute a single optimal curve fit solution across all approximate total sales rank regimes or groupings at once, that provides distinct parameters x₀, x₁, and x₂ for each approximate total sales rank regime or grouping's curve that together in combination yield the lowest sum-total overall mean-squared error (MSE) across all approximate total sales rank regimes or groupings, while meeting cleanly at the approximate total sales rank regime or grouping boundaries. Accordingly, recasting the above constrained convex optimization problem into matrix form, provides the following: minimize ∥Ax−b∥2, subject to Cx=d,
where m is the number of approximate total sales rank breakpoints (e.g., approximate total sales rank=100, 1000, 10000, etc.) defined to separate the curve into m+1 different approximate total sales rank regimes or groupings for which distinct regime-specific log-quadratic curve-fit parameters are generated.
n is the total count of WUS/approximate total sales rank data pairs to be curve-fitted, while n₀, n₁, n₂, . . . , nₘ are the counts of WUS/approximate total sales rank data pairs that fall into each approximate total sales rank regime or grouping defined above (where, n=n₀+n₁+n₂+ . . . +nₘ)
A is a n×3m input matrix, populated as defined below
b is a 3m×1 input matrix (vector), populated as defined below
C is a 2m×3m input constraint matrix, populated as defined below
d is a 2m×1 matrix (vector) of zeroes, as defined below
x is the 3m×1 solution matrix (vector) which will contain the optimal curve-fit parameters for each regime or grouping, laid out as defined below

$$A = [ \begin{matrix}1 & {log}_{10} ( {SR}_{0 , 1} ) & {[ {log}_{10} ( {SR}_{0 , 1} ) ]}^{2} & 0 & 0 & 0 & 0 & 0 & 0 & … & 0 & 0 & 0 \\ 1 & {log}_{10} ( {SR}_{0 , 2} ) & {[ {log}_{10} ( {SR}_{0 , 2} ) ]}^{2} & 0 & 0 & 0 & 0 & 0 & 0 & … & 0 & 0 & 0 \\ ⋮ & ⋮ & ⋮ & ⋮ & ⋮ & ⋮ & ⋮ & ⋮ & ⋮ & ⋱ & ⋮ & ⋮ & ⋮ \\ 1 & {log}_{10} ( {SR}_{0 , {n}_{0}} ) & {[ {log}_{10} ( {SR}_{0 , {n}_{0}} ) ]}^{2} & 0 & 0 & 0 & 0 & 0 & 0 & … & 0 & 0 & 0 \\ 0 & 0 & 0 & 1 & {log}_{10} ( {SR}_{1 , 1} ) & {[ {log}_{10} ( {SR}_{1 , 1} ) ]}^{2} & 0 & 0 & 0 & … & 0 & 0 & 0 \\ 0 & 0 & 0 & 1 & {log}_{10} ( {SR}_{1 , 2} ) & {[ {log}_{10} ( {SR}_{1 , 2} ) ]}^{2} & 0 & 0 & 0 & … & 0 & 0 & 0 \\ ⋮ & ⋮ & ⋮ & ⋮ & ⋮ & ⋮ & ⋮ & ⋮ & ⋮ & ⋱ & ⋮ & ⋮ & ⋮ \\ 0 & 0 & 0 & 1 & {log}_{10} ( {SR}_{1 , {n}_{1}} ) & {[ {log}_{10} ( {SR}_{1 , {n}_{1}} ) ]}^{2} & 0 & 0 & 0 & … & 0 & 0 & 0 \\ 0 & 0 & 0 & 0 & 0 & 0 & 1 & {log}_{10} ( {SR}_{2 , 1} ) & {[ {log}_{10} ( {SR}_{2 , 1} ) ]}^{2} & … & 0 & 0 & 0 \\ 0 & 0 & 0 & 0 & 0 & 0 & 1 & {log}_{10} ( {SR}_{2 , 2} ) & {[ {log}_{10} ( {SR}_{2 , 2} ) ]}^{2} & … & 0 & 0 & 0 \\ ⋮ & ⋮ & ⋮ & ⋮ & ⋮ & ⋮ & ⋮ & ⋮ & ⋮ & ⋱ & ⋮ & ⋮ & ⋮ \\ 0 & 0 & 0 & 0 & 0 & 0 & 1 & {log}_{10} ( {SR}_{2 , {n}_{2}} ) & {[ {log}_{10} ( {SR}_{2 , {n}_{2}} ) ]}^{2} & … & 0 & 0 & 0 \\ ⋮ & ⋮ & ⋮ & ⋮ & ⋮ & ⋮ & ⋮ & ⋮ & ⋮ & ⋱ & ⋮ & ⋮ & ⋮ \\ 0 & 0 & 0 & 0 & 0 & 0 & 0 & 0 & 0 & … & 1 & {log}_{10} ( {SR}_{m , 1} ) & {[ {log}_{10} ( {SR}_{m , 1} ) ]}^{2} \\ 0 & 0 & 0 & 0 & 0 & 0 & 0 & 0 & 0 & … & 1 & {log}_{10} ( {SR}_{m , 2} ) & {[ {log}_{10} ( {SR}_{m , 2} ) ]}^{2} \\ ⋮ & ⋮ & ⋮ & ⋮ & ⋮ & ⋮ & ⋮ & ⋮ & ⋮ & ⋱ & ⋮ & ⋮ & ⋮ \\ 0 & 0 & 0 & 0 & 0 & 0 & 0 & 0 & 0 & … & 1 & {log}_{10} ( {SR}_{m , {n}_{m}} ) & {[ {log}_{10} ( {SR}_{m , {n}_{m}} ) ]}^{2}\end{matrix} ]$$

$$b = [ \begin{matrix}{WUS}_{0 , 1} \\ {WUS}_{0 , 2} \\ ⋮ \\ {WUS}_{0 , {n}_{0}} \\ {WUS}_{1 , 1} \\ {WUS}_{1 , 2} \\ ⋮ \\ {WUS}_{1 , {n}_{1}} \\ {WUS}_{2 , 1} \\ {WUS}_{2 , 2} \\ ⋮ \\ {WUS}_{2 , {n}_{2}} \\ ⋮ \\ {WUS}_{m , 1} \\ {WUS}_{m , 2} \\ ⋮ \\ {WUS}_{m , {n}_{m}}\end{matrix} ]$$

$$C = [ \begin{matrix}\text{?} & \text{?} & \text{?} & \text{?} & \text{?} & \text{?} & \text{?} & \text{?} & \text{?} & \text{?} & \text{?} & \text{?} & \text{?} & \text{?} & \text{?} & \text{?} \\ \text{?} & \text{?} & \text{?} & \text{?} & \text{?} & \text{?} & \text{?} & \text{?} & \text{?} & \text{?} & \text{?} & \text{?} & \text{?} & \text{?} & \text{?} & \text{?} \\ \text{?} & \text{?} & \text{?} & \text{?} & \text{?} & \text{?} & \text{?} & \text{?} & \text{?} & \text{?} & \text{?} & \text{?} & \text{?} & \text{?} & \text{?} & \text{?} \\ \text{?} & \text{?} & \text{?} & \text{?} & \text{?} & \text{?} & \text{?} & \text{?} & \text{?} & \text{?} & \text{?} & \text{?} & \text{?} & \text{?} & \text{?} & \text{?} \\ \text{?} & \text{?} & \text{?} & \text{?} & \text{?} & \text{?} & \text{?} & \text{?} & \text{?} & \text{?} & \text{?} & \text{?} & \text{?} & \text{?} & \text{?} & \text{?} \\ \text{?} & \text{?} & \text{?} & \text{?} & \text{?} & \text{?} & \text{?} & \text{?} & \text{?} & \text{?} & \text{?} & \text{?} & \text{?} & \text{?} & \text{?} & \text{?} \\ \text{?} & \text{?} & \text{?} & \text{?} & \text{?} & \text{?} & \text{?} & \text{?} & \text{?} & \text{?} & \text{?} & \text{?} & \text{?} & \text{?} & \text{?} & \text{?}\end{matrix} \text{?}$$

$$D = [ \begin{matrix}0 \\ 0 \\ 0 \\ 0 \\ ⋮ \\ 0 \\ 0\end{matrix} ]$$

$$x = [ \begin{matrix}{x}_{0 , 0} \\ {x}_{0 , 1} \\ {x}_{0 , 2} \\ {x}_{1 , 0} \\ {x}_{1 , 1} \\ {x}_{1 , 2} \\ {x}_{2 , 0} \\ {x}_{2 , 1} \\ {x}_{2 , 2} \\ ⋮ \\ {x}_{m , 0} \\ {x}_{m , 1} \\ {x}_{m , 2}\end{matrix} ]$$

$$\text{?} \text{indicates text missing or illegible when filed}$$

where SR_{y,z}=the approximate total sales rank of data point z within regime y (i.e. having a SalesRank lying between breakpoint y−1 and y)
WUS_{y,z}=the WUS of data point z within regime y (i.e. having an approximate total sales rank lying between breakpoint y−1 and y)
SR_{bpy}=the approximate total sales rank at breakpoint x (i.e. breakpoint separating regimes y and y+1)
x_{y,0}=the constant-term parameter for the optimal constrained curve-fit for regime y
x_{y,1}=the linear-term parameter for the optimal constrained curve-fit for regime y
x_{y,2}=the quadratic-term parameter for the optimal constrained curve-fit for regime y

To determine a solution of a constrained least squares problem laid out as above, the computing device 101 may, for example, form the Lagrangian function, which, for example, may at the optimum solution point have zero slope in every direction. As such, the Karush-Kuhn-Tucker (KKT) conditions dictate that, for optimality, the matrices above may satisfy the condition:

$$[ \begin{matrix}2 {A}^{T} A & {C}^{T} \\ C & 0\end{matrix} ] [ \begin{matrix}\hat{x} \\ z\end{matrix} ] = [ \begin{matrix}2 {A}^{T} b \\ d\end{matrix} ]$$

where \hat{x} is the optimal solution vector of curve-fit parameters x, and z is the vector of Lagrange multipliers. For example, the computing device 101 may invert the KKT matrix above to obtain the optimal solution to \hat{x} via:

$$[ \begin{matrix}\hat{x} \\ z\end{matrix} ] = {[ \begin{matrix}2 {A}^{T} A & {C}^{T} \\ C & 0\end{matrix} ]}^{- 1} [ \begin{matrix}2 {A}^{T} b \\ d\end{matrix} ] .$$

For example, the computing device 101 may determine the optimal curve fit by running multiple iterative passes of the above matrix computation, and may, each time, exclude from the next computation individual data points that lie further than a first threshold factor (e.g., 1.5×) above and/or a second threshold factor (e.g., 0.5×) below the previous iteration's determined curve. While the example above uses 1.5× for the first threshold factor and 0.5× for the second threshold factor, in other examples, the threshold factors can be any number between 0.001-20). This may be done until the solution fully converges (e.g., there are no more outliers left or the number of outliers is below a threshold amount) or a pre-set maximum iteration count is reached. FIG. 8 shows an example graph 800 showing the optimal curve fit 805 based on the plotting of the graph 700 of data shown in FIG. 7. For example, the optimal curve fit may yield the following formulas for determining the period unit sales amount for each digital book of the plurality of digital books at the respective retailer within each regime or grouping:

$$Approximate total sales rank 1 - 100 : {log}_{10} ( WUS ) = 3.70396835100276 \; 52 - 0.1383533968917675 [ {log}_{10} ( SR ) ] - 0.08741441645870618 {( [ {log}_{10} ( SR ) ] )}^{2} \\ Approximate total sales rank 101 - 1 , 000 : {log}_{10} ( WUS ) = 4.934152964469581 - 1.0860241942268942 [ {log}_{10} ( SR ) ] + 0.07887482884125951 {( [ {log}_{10} ( SR ) ] )}^{2} \\ Approximate total sales rank 1 , 001 - 10 , 000 : {log}_{10} ( WUS ) = 3.7067352897607915 - 0.22312486349889582 [ {log}_{10} ( SR ) ] + 0.07237853976532449 {( [ {log}_{10} ( SR ) ] )}^{2} \\ Approximate total sales rank 10 , 000 - 100 , 000 : {log}_{10} ( WUS ) = 1.861352933842175 - 0.7359702687463141 [ {log}_{10} ( SR ) ] - 0.19681592558441707 {( [ {log}_{10} ( SR ) ] )}^{2} \\ Approximate total sales rank >= 100 , 001 : {log}_{10} ( WUS ) = - 34.41694386203669 + 15.6187 [ {log}_{10} ( SR ) ] - 1.72223 {( [ {log}_{10} ( SR ) ] )}^{2}$$

Those of ordinary skill in the art will recognize that the above formulas for the approximate total sales rank regimes or groupings are an example only and determined based on example approximate total sales rank and WUS data for a retailer. The formulas for other retailers, determined based on optimal curve fit would likely be different and vary from retailer to retailer.

At 416, a period unit sales amount may be determined for each digital book title for the plurality of retailers. For example, the determination may be made by the computing device 101 or any other computing device described herein. For example, the period unit sales amount may represent the estimated unit sales amount for the digital book title during the period (e.g., day, 24 hours, week, month, calendar quarter, year, etc.). For example, the period unit sales amount for the digital book title may be determined for each retailer of the plurality of retailers and then summed together to get the period unit sales about for the digital book title for the plurality of retailers. For example, the period unit sales amount for each digital book title may be determined based on the approximate total sales rank for the particular digital book title. For example, the period unit sales amount for each digital book title may be determined based on the approximate total sales rank for the particular digital book title and the digital book format for the particular digital book title.

For example, on a periodic (e.g., nightly, daily, weekly, monthly, quarterly, etc.) basis, the computing device 101 may determine period unit sales amount and total period sales value at the digital book title level for each e-book, audiobook, and printed-book sold online at each retailer tracked as described above. For example, the period unit sales amount may be determined by determining the current WUS for each digital book title from its approximate total sales rank, as determined above, during the period using the most up-to-date calibrated optimal curve-fit for the particular retailer, as follows:

$${WUS}_{current} = 1 {0}^{( {x}_{0} + {x}_{1} [ {log}_{10} ( {SR}_{current} ) ] + {{x}_{2} ( [ {log}_{10} ( {SR}_{current} ) ] )}^{2} )}$$

where SR_{current}=the approximate total sales rank (e.g., today's latest determined approximate total sales rank) for a given digital book title
X₀, X₁, and X₂=the most up-to-date constant, linear, and quadratic parameters computed for the book's retailer, format, and the approximate total sales rank regime that SR_{current} lies within
WUS_{current}=the current computed WUS for that digital book title
   Then, for each digital book title, its period unit sales amount may be determined by attenuating the previous WUS value stored for that digital book title yesterday, and subtracting it from the current WUS to yield the book title's period unit sales amount:

$$Period Unit Sales Amount = {WSU}_{current} - ( {[ \frac{1}{{D}_{r , f}} ]}^{( {t}_{current} - {t}_{previous} )} {WUS}_{previous} )$$

where t_{current}=today's timestamp (today's approximate total sales rank determined for a digital book title)
tₚᵣₑᵥᵢₒᵤₛ=yesterday's (or prior) timestamp (corresponding to timestamp of approximate total sales rank from which previous WUS was determined for that digital book title)
WUS_{current}=today's determined WUS for the digital book title
WUSₚᵣₑᵥᵢₒᵤₛ=previous WUS determined for that book title
D_{r,f}=the retailer- and format-specific daily (or hourly) decay rate, which is the rate at which the contribution to a digital book title's WUS by older sales decays over time relative to the contribution of more recent sales to that digital book title's WUS.

In addition, the computing device 101 may determine a sales price for each particular digital book title of the plurality of digital book titles and each available digital book format for the respective digital book title. For example, the sales price may be determined from the plurality of digital book data received or retrieved from the book retailer websites 160A-C. For example, the sales price may be the same for each digital book format or may be different for one or more of the digital book formats for a respective digital book title. The computing device 101 may determine a period sales value for each respective digital book title at each respective retailer of the plurality of retailers. For example, the period sales value may be determined based on the sales price for each respective digital book title and format for each respective retailer of the plurality of retailers and the period sales of each digital book title in the particular format for each respective retailer. For example, the period sales value for a particular format of a digital book title may be determined by multiplying the period sales for the particular format of the digital book title at a retailer by the sales price for that digital book title in that format at that retailer. The period sales value for the digital book title may further be determined by summing the period sales value for each particular format of the digital book title at that retailer.

The computing device 101 may further determine the total period sales value for each respective digital book title of the plurality of digital book titles. For example, determining the total period sales value may be based on the period sales value for the particular respective book title of the plurality of digital book titles at each retailer of the plurality of retailers. For example, the computing device 101 may take the sum of all of the period sales values at all of the plurality of retailers that have sold the particular digital book title during the period to result in the total period sales value. The computing device 101 may create and or retrieve a record associated with the digital book title and add the total period sales value for the particular period into the record. The computing device 101 may further add or include in the record, the digital book metadata for the particular digital book title received or retrieved from the plurality of digital book data.

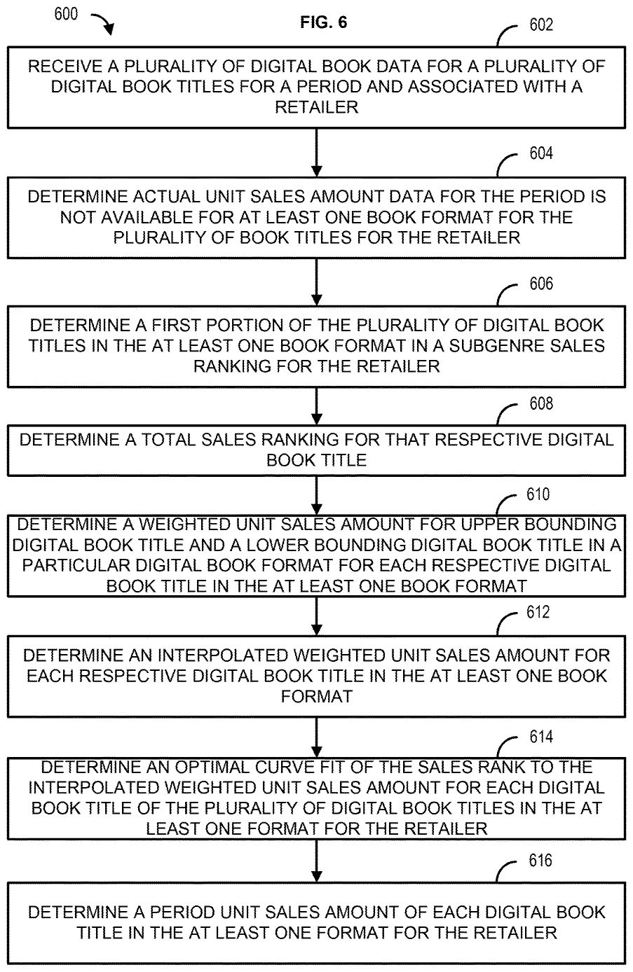

For some specific digital book formats at some retailers of the plurality of retailers, the data calibration providers 132 may only provide and the computing device 101 may only receive or retrieve weekly-, monthly-, or quarterly-aggregated actual sales totals on a per-digital book title basis and not actual period sales data for one or more of the specific digital book formats. In that example embodiment, the computing device 101 may use another example variant method 600, as shown in FIG. 6, to generate the optimal sales rank-to-WUS curve fits used. For example, the method 600 may be completed by the computing device 101 or any other computing device described herein. For example, a digital book format may be one or more of an electronic book (or e-book), an audio book, or a print book.

At 602, a plurality of digital book data for a plurality of digital book titles for a period of time may be received or retrieved. For example, the plurality of digital book data may be received by the computing device 101 or any other computing device described herein. For example, the plurality of digital book data may be received or retrieved from a digital book retailer website 160A-C. While the example method 600 will be described with reference to a single retailer, the method 600 disclosed herein may be repeated for each additional retailer of the plurality of retailers for which the above-referenced data is determined to not be available. For example, the period of time or time period may be a day, 24 hours, a week, a month, a year, or a quarter of a calendar year. For example, the plurality of digital book data may comprise digital book title-level metadata. For example, the plurality of digital book data (e.g., the digital book title-level metadata) may comprise one or more of a sales price, a list price, a total sales ranking, a genre sales ranking, or a subgenre sales ranking.

For example, the plurality of digital book data for the plurality of digital book titles may include raw data collected to be able compute market-wide digital book sales. For example, the plurality of digital book data may include a plurality of webpages captured on a periodic (e.g., daily, 24 hour, weekly, monthly, quarterly) basis from the digital (e.g., online) book retailer. For example, the plurality of digital book data may comprise a plurality of genre-specific retailer bestseller ranking lists with relative sales rankings for digital books in each or a particular book format (e.g., e-book, audiobook, and print books) in those genres/subgenre, such as, but not limited to, Top 100 Cozy Mysteries, Top 100 Biographies of Sports Leaders, Top 100 Teen & Young Adult Urban Fantasy Novels, etc.

For example, the plurality of digital book data may comprise a plurality of retailer “product description” webpages for specific e-books, audiobooks, and print books that the one or more computing devices discover on the above ranking lists, as “also-boughts” associated with other books (e.g., “readers who bought this book also bought these other books . . . ”) or which are determined herein to be likely nonzero-sellers that period due to having nonzero sales over the previous seven days. For example, the product-description webpages may contain relevant digital book metadata. For example, the digital book metadata may comprise one or more of the title, author, publisher label, publication date, retailer stock keeping unit (SKU), international standard book number (ISBN), and/or narrator (for audiobooks). These pages and the digital book metadata may also contain sale price for the digital book in the particular format, list price for the digital book in the particular format, and (for some retailers) an total sales ranking for that digital book out of all the digital books of that format (e.g., e-book, audiobook, print book, etc.) sold at that retailer. For example, the plurality of digital book data may comprise a plurality of ISBN cross-lookups of digital books found at one retailer to discover their equivalent SKUs, data, and sales at other retailers. For example, the plurality of digital book data may comprise a plurality of book cover-image matching scores (via machine-learning analysis) for pairs of non-ISBN-bearing book SKUs at different retailers that fuzzy metadata matching, using machine-learning method disclosed herein, indicates are likely to be different-retailer editions of the same digital book title.

The computing device 101 may comprise or make use of a plurality of high-powered data scrapers 130A-C, and may use aggressive brute force retry strategies (which may average many hundreds of millions of page requests per period (e.g., day)), and routing of all automated webpage HTTP requests through hundreds of thousands of disparate IP addresses within each market or portion of the market (e.g., city, state, country, or group of countries) to be evaluated and for which digital book data will be collected.

The pluggable proxy architecture of the computing device 101 allows it to use an interchangeable selection of different proxy vendors to provide the hundreds of thousands of country-specific proxy IP addresses through which the plurality of digital book data is retrieved or received on a periodic (e.g., daily, 24 hour, weekly, monthly, quarterly, etc.) basis, such as millions of pages of HTML digital book rankings and book product pages from retailer websites.

For each retailer and digital book format sold at each retailer, the computing device 101 may determine, to within precise statistical limits, the shape of the “long tail” of that distribution, and therefore, roughly what overall sales ranking may correspond to zero sales in the last period (e.g., last day, 24 hours, week, month, quarter, etc.). The computing device 101 may use this information to “steer” the collection process throughout the period reactively and in real-time, to increase the possibility that the digital book sales data captures data on all digital books selling at least one copy during the particular period, while capturing data on as few digital books that had zero sales during the period.

For example, the digital book data may include

At 604, actual unit sales amounts for the period (e.g., day, 24 hours, week, month, calendar quarter) may be determined to not be available for at least one digital book format for the plurality of digital book titles being sold by the retailer. For example, the determination may be made by the computing device 101 or any other computing device described herein. For example, actual unit sales amounts for the period for at least a portion of the plurality of digital book titles may be received by the computing device 101 or any other computing device described herein. For example, the determination may be based on the plurality of digital book data. For example, the actual unit sales amounts for at least the portion of the plurality of digital book titles may be received from one or more (e.g., a plurality of) data calibration providers 132 via the network 140 or another network. For example, the data calibration providers 132 may comprise one or more publishers of digital book titles. The data calibration providers 132 may provide the computing device 101 with a plurality of feeds of title-level unit sales actuals for the period and for all of or a portion of their published digital book titles (e.g., e-books, audiobooks, and/or online print book sales). For example, the computing device 101 may evaluate the actual unit sales amount data received and determine that the actual unit sales amount data does not include actual unit sales amount data for at least one digital book format (e.g., e-book, audiobook, print book). For example, the computing device 101 may determine that the actual unit sales amount data received and related to the retailer does not include actual unit sales amount data for digital book titles in the print book format. This is for example only for purpose of describing the method 600 as the actual unit sales amount data may be missing for e-books and/or audiobooks in other examples.

The computing device 101 may determine that the digital book data for the retailer includes one or more (e.g., a plurality of) mixed-format subgenre ranking lists that include top-selling e-books, audiobooks, and print books selling in that specific subgenre. At 606, a first portion of the plurality of digital book titles in the at least one book format, for which actual unit sales amount data is not available, may be determined to be in one or more of the subgenre mixed format rankings list. For example, the determination may be made by the computing device 101 or any other computing device described herein. For example, the determination may be based on the plurality of digital book data.

At 608, for each respective digital book title of the first portion of the plurality of digital book titles in the format for which actual unit sales amount data is not available, a total sales ranking for that respective digital book title in that format may be determined. For example, the determination may be made by the computing device 101 or any other computing device described herein. For example, the determination may be based on the plurality of digital book data. For example, for each print book on one or more of the plurality of mixed-format subgenre rankings lists, the computing device 101 may determine that particular print book's overall total sales rank from that particular retailers product page 160A-C.

For example, the computing device 101 may determine the nearest bounding e-book (or other digital book format (e.g., audiobook, print book for which total sales data is available) on the same ranking list with a ranking (e.g., ListRank) above that of the print book's ranking, and the nearest bounding e-book on the same ranking list with a ranking below that of the print book's ranking. While the example describes looking for the nearest bounding e-book, this is for example purposes only as another digital book format (e.g., audiobook, print book, etc.) may be alternatively evaluated if sales data is available for that particular format. For example, the computing device 101 may also separately captured overall total sales ranking for those bounding e-books within a predetermined amount of time (e.g., any amount of time between and including 1 second and 24 hours, such as 1 hour) of receiving or determining the total sales ranking of the particular print-book digital book title.

At 610, weighted unit sales (WUS) for the nearest upper bounding e-book on the same ranking list and the nearest lower bounding e-book on the same ranking list may be determined. For example, the determination may be made by the computing device 101 or any other computing device described herein. For example, the determination may be based on the overall total sales ranking for those upper and lower bounding digital book titles in the e-book format. This may be done for each digital book title in the at least one format in each of the subgenre sales rankings. For example, for each pair of bounding e-books, upper and lower weighted unit sales (WUS) values are computed as follows:

$${WUS}_{ebook , upperbound} = {10}^{( {x}_{eu , o} + {x}_{eu , 1} [ {log}_{10} ( S {R}_{ebookupperbound} ) ]} + {{x}_{e u , 2} ( [ {log}_{10} ( S {R}_{ebook , upperbound} ) ] )}^{2} ) \\ {WUS}_{ebook , upperbound} = {10}^{( {x}_{eu , o} + {x}_{eu , 1} [ {log}_{10} ( S {R}_{ebookupperbound} ) ]} + {{x}_{e u , 2} ( [ {log}_{10} ( S {R}_{ebook , upperbound} ) ] )}^{2} )$$

where SR_{e-book,upperbound}=the overall total sales rank of the upper-bounding e-book
SR_{e-book,lowerbound}=the overall total sales rank of the lower-bounding e-book
X_{eu,0}, X_{eu,1}, and X_{eu,2}=the constant, linear, and quadratic parameters previously computed for the e-book overall total sales rank regime that SR_{e-book,upperbound} lies within.
X_{el,0}, X_{el,1}, and X_{el,2}=the constant, linear, and quadratic parameters previously computed for the e-book overall total sales rank regime that SR_{e-book,lowerbound} lies within.
WUS_{e-book,upperbound}=the determined WUS of the upper-bounding e-book
WUS_{e-book,lowerbound}=the determined WUS of the lower-bounding e-book

At 612, an interpolated weighted unit sales amount for each respective digital book title in the at least one digital book format, for which actual unit sales amount data is not available, may be determined. For example, the determination may be made by the computing device 101 or any other computing device described herein. For example, the interpolated weighted unit sales amount for the respective digital book title may be determined based on the corresponding weighted unit sales amount for the upper bounding digital book title and the lower bounding digital book title in the e-book format for that respective digital book title in the at least one format (e.g., a print book format). As such, an interpolated WUS may be determined for each of the digital book titles in the at least one format for which actual unit sales amount data is not available for the particular retailer. For example, the interpolated WUS may be used in place of the WUS which could not be determined because of a lack of actual unit sales amount data for each of the digital book titles in the at least one format. For example, the interpolated WUS for the particular digital book title in the at least one format may be determined as follows:

$${InterpolatedWUS}_{p r i nted - book} = {WUS}_{ebook , lowerbound} ( \frac{{ListRank}_{p i n t e d - b o o k} - {ListRank}_{ebook , uppbound}}{L i s t R a n {k}_{e b o ok , lowerbound} - {ListRank}_{e b o ok , upperbound}} ) + {WUS}_{e book , upperbound} ( \frac{L i s t R a n {k}_{e b o ok , lowerbound} - L i s t R a n {k}_{printed - b o o k}}{L i s t R a n {k}_{e b o ok , lowerbound} - L i s t R a n {k}_{e b o ok , upperbound}} )$$

For example, the particular digital book title in the at least one digital book format may appear on a plurality of mixed-format subgenre ranking lists, resulting in multiple possible interpolated WUS for that particular digital book title in that at least one format. As such, the computing device 101 may also determine an interpolated WUS error range associated with each of the interpolated WUS determined from each subgenre ranking list for the particular digital book title as follows:

$${InterpolatedWUSerrorrange}_{s u bgenre , printed - book} = \frac{\begin{matrix}MAX ( 0.5 , MAX ( {WUS}_{subgenre , ebook , lowerbound} , \\ {WUS}_{subgenre , ebook , upperbound} ) )\end{matrix}}{\begin{matrix}MAX ( 0.5 , MIN ( {WUS}_{subgenre , ebook , upperbound} , \\ {WUS}_{subgenre , ebook , lowerbound} ) )\end{matrix}}$$

where WUS_{subgenre,e-book,lower-bound}=the WUS determined for the printed-book's lower-bounding e-book on the subgenre list per the above
WUS_{subgenre,e-book,upper-bound}=the WUS determined for the printed-book's upper-bounding e-book on the subgenre list per the above
InterpolatedWUSerrorrange_{subgenre,printed-book}=the potential error range associated with InterpolatedWUS_{subgenre,printed-book}
   The computing device 101 may then determine InterpolatedWUS_{subgenre,printed-book} with the lowest associated InterpolatedWUSerrorrange_{subgenre,printed-book} as the interpolated WUS for the particular digital book title in the at least one format to use for plotting and curve fitting.

For digital book titles in other formats which have actual unit sales amount data, the WUS may be calculated for those digital book titles in those other formats substantially as described in 206 of FIG. 2.

At 614, an optimal curve fit of the sales rank to the weighted unit sales (WUS) amount and/or interpolated WUS amount for each digital book title of the plurality of digital book titles for the retailer in each format of the plurality of digital book formats may be determined. For example, the determination may be made by the computing device 101 or any other computing device described herein. For example, the optimal curve fit may be an optimal log quadratic curve fit of the sales rank to the weighted unit sales amount. For example, a plurality of periodic (e.g., daily, weekly, monthly, quarterly, etc.) weighted unit sales determined for a plurality (e.g., hundreds, thousands, hundreds of thousands, etc.) of digital book titles in one or more formats from a corresponding true daily title-level sales, as provided by one or more data calibration providers 132 (e.g., a plurality of calibration data partner publishers), and a plurality of periodic interpolated WUS determined for all or at least a portion of the plurality of digital book titles in one or more other formats may be graphically plotted with the determined corresponding sales rank for the digital book title at the retailer for each of plurality of digital book titles during that same period (e.g., day, week, month, calendar quarter, etc.) in the same manner as substantially shown in the graph 700 of FIG. 7. For example, the graph 700 provides a period-based (e.g., daily, 24 hours, weekly, monthly, quarterly, etc.) scatter-plot that maps Sales Rank to WUS for each digital book title in a particular format for a particular retailer of the plurality of retailers.

Referring to the graph 700, each dot in the plot corresponds to a single digital book title for a single period (e.g., day, 24 hours, week, month, calendar quarter, etc.), and cross-plots its corresponding weighted unit sales at a given retailer against that digital book title's sales rank at the particular retailer during that period. For example, both axes of the graph 700 may be logarithmic. For example, when displayed in logarithmic form, a roughly quadratic relationship may be observed between WUS and/or interpolated WUS and sales rank.

For example, a decay rate (D_{r,f}) for the retailer and for each digital book format may be determined. For example, the decay rate may be determined by the computing device 101 or any other computing device described herein. For example, the decay rate may be determined based on the title-level daily unit sales actuals. For example, the weighted unit sales may be determined based on the determined decay rate for the particular retailer and digital book format being evaluated.

For example, determining the decay rate could include experimental measurement of impulse responses (decaying ranking over time) over the hours/days following a timed purchase of a title that is otherwise non-selling, or following a timed step-function increase in the purchase rate of a steadily selling title. More generally, the decay rate for a particular retailer may be determined using a group of titles where both true unit sales and sales rankings are known for a multi-day period, and then parametrically varying the decay rate while scatter-plotting each title's weighted unit sales vs sales-rank. Then it can be observed what parametric value of decay rate causes the mathematically smallest overall sum of weighted least-square-errors (and thus the tightest observable “banding” of scatterplot values at different sales-rankings).

For example, the sales rank to the weighted unit sales or interpolated WUS for each digital book title of the plurality of digital book titles and in each format is plotted on the graph 700 for the retailer. For example, a separate graph 700 may be plotted for each respective retailer of a plurality of retailers or for at least a portion of the respective retailers of the plurality of retailers. For example, the sales rank and weighted unit sales or interpolated WUS for each digital book title may be plotted by the computing device 101 or any other computing device described herein.

For example, an optimal curve fit for the retailer may be determined. For example, the determination may be made by the computing device 101 or any other computing device described herein. For example, the optimal curve fit may be an optimal log quadratic curve fit of the sales rank to the weighted unit sales amount or interpolated WUS for the plurality of digital book titles in each format sold by the retailer. For example, both input and output of the optimization problem may be cast as logarithmic (e.g., the logarithm of sales rank as a quadratic function of the logarithm of WUS or interpolated WUS).

For example, for each sales rank grouping or regime (e.g., sales ranks 1-100, sales ranks 100-1,000, sales ranks 1,000-10,000, sales ranks 10,000-100,000, and sales ranks greater than 100,000), convex optimization matrix techniques may be used to determine the optimal corresponding regime-specific parameters x₀, x₁, and x₂ that yield the overall minimum-square-error (MSE) fit across all sales rank and WUS or interpolated WUS pairings that land in that grouping or regime, in accordance with the following quadratic equation:

$${log}_{10} ( WUS ) = {x}_{0} + {x}_{1} [ {log}_{10} ( S R ) ] + {{x}_{1} ( [ {log}_{10} ( S R ) ] )}^{2}$$

where SR=sales rank
WUS=Weighted Unit Sales or interpolated weighted unit sales

In addition, in order to limit or control discontinuous curve fits when creating the optimal curve fit, the computing device 101 may determine that each pair of adjacent curve-fits must meet each other exactly at the regime boundary between them. For example, at sales rank 100, the WUS or interpolated WUS determined via the parameterized curve for sales ranks 1-100 must exactly match the WUS or interpolated WUS determined via the parameterized curve for sales ranks 100-1,000. In addition, at sales rank 10,000 the WUS or interpolated WUS determined via the parameterized curve for sales ranks 1,000-10,000 must exactly match the WUS or interpolated WUS determined via the parameterized curve for sales ranks 10,000-100,000.

In addition, in order to limit or control discontinuous curve fits when creating the optimal curve fit, the computing device 101 may determine the slope of each pair of adjacent curve-fits must exactly (or approximately or substantially) match at the regime boundary between them. For example, at sales rank 100, the WUS or interpolated WUS determined via the parameterized curve for sales rank 1-100 must exactly, approximately, or substantially match the WUS or interpolated WUS determined via the parameterized curve for sales rank 100-1,000. In addition, at sales rank 10,000 the WUS or interpolated WUS determined via the parameterized curve for sales ranks 1,000-10,000 must exactly, approximately, or substantially match the WUS or interpolated WUS determined via the parameterized curve for sales ranks 10,000-100,000.)

As such, in certain example embodiments, it may be preferable to compute a single optimal curve fit solution across all sales rank regimes or groupings at once, that provides distinct parameters x₀, x₁, and x₂ for each sales rank regime or grouping's curve that together in combination yield the lowest sum-total overall mean-squared error (MSE) across all sales rank regimes or groupings, while meeting cleanly at the sales rank regime or grouping boundaries. Accordingly, recasting the above constrained convex optimization problem into matrix form, provides the following: minimize ∥Ax−b∥2, subject to Cx=d,
where m is the number of sales rank breakpoints (e.g., sales rank=100, 1000, 10000, etc.) defined to separate the curve into m+1 different sales rank regimes or groupings for which distinct regime-specific log-quadratic curve-fit parameters are generated.
n is the total count of WUS or interpolated WUS/sales rank data pairs to be curve-fitted, while n₀, n₁, n₂, . . . , nₘ are the counts of WUS or interpolated WUS/sales rank data pairs that fall into each sales rank regime or grouping defined above (where, n=n₀+n₁+n₂+ . . . +nₘ)
A is a n×3m input matrix, populated as defined below
b is a 3m×1 input matrix (vector), populated as defined below
C is a 2m×3m input constraint matrix, populated as defined below
d is a 2m×1 matrix (vector) of zeroes, as defined below
x is the 3m×1 solution matrix (vector) which will contain the optimal curve-fit parameters for each regime or grouping, laid out as defined below

$$A = [ \begin{matrix}1 & {log}_{10} ( {SR}_{0 , 1} ) & {[ {log}_{10} ( {SR}_{0 , 1} ) ]}^{2} & 0 & 0 & 0 & 0 & 0 & 0 & … & 0 & 0 & 0 \\ 1 & {log}_{10} ( {SR}_{0 , 2} ) & {[ {log}_{10} ( {SR}_{0 , 2} ) ]}^{2} & 0 & 0 & 0 & 0 & 0 & 0 & … & 0 & 0 & 0 \\ & & & & & & & & & & & & \\ ⋮ & ⋮ & ⋮ & ⋮ & ⋮ & ⋮ & ⋮ & ⋮ & ⋮ & ⋱ & ⋮ & ⋮ & ⋮ \\ & & & & & & & & & & & & \\ 1 & {log}_{10} ( {SR}_{0 , {n}_{0 }} ) & {[ {log}_{10} ( {SR}_{0 , {n}_{0}} ]}^{2} & 0 & 0 & 0 & 0 & 0 & 0 & … & 0 & 0 & 0 \\ 0 & 0 & 0 & 1 & {log}_{10} ( {SR}_{1 , 1} ) & {[ {log}_{10} ( {SR}_{1 , 1} ) ]}^{2} & 0 & 0 & 0 & … & 0 & 0 & 0 \\ 0 & 0 & 0 & 1 & {log}_{10} ( {SR}_{1 , 2} ) & {[ {log}_{10} ( {SR}_{1 , 2} ) ]}^{2} & 0 & 0 & 0 & … & 0 & 0 & 0 \\ ⋮ & ⋮ & ⋮ & ⋮ & ⋮ & ⋮ & ⋮ & ⋮ & ⋮ & ⋱ & ⋮ & ⋮ & ⋮ \\ 0 & 0 & 0 & 1 & {log}_{10} ( {SR}_{1 , {n}_{1}} ) & {[ {log}_{10} ( {SR}_{1 , {n}_{1}} ) ]}^{2} & 0 & 0 & 0 & … & 0 & 0 & 0 \\ 0 & 0 & 0 & 0 & 0 & 0 & 1 & {log}_{10} ( {SR}_{2 , 1} ) & {[ {log}_{10} ( {SR}_{2 , 1} ) ]}^{2} & … & 0 & 0 & 0 \\ 0 & 0 & 0 & 0 & 0 & 0 & 1 & {log}_{10} ( {SR}_{2 , 2} ) & {[ {log}_{10} ( {SR}_{2 , 2} ) ]}^{2} & … & 0 & 0 & 0 \\ ⋮ & ⋮ & ⋮ & ⋮ & ⋮ & ⋮ & ⋮ & ⋮ & ⋮ & ⋱ & ⋮ & ⋮ & ⋮ \\ 0 & 0 & 0 & 0 & 0 & 0 & 1 & {log}_{10} ( {SR}_{2 , {n}_{2}} ) & {[ {log}_{10} ( {SR}_{2 , {n}_{2}} ) ]}^{2} & … & 0 & 0 & 0 \\ ⋮ & ⋮ & ⋮ & ⋮ & ⋮ & ⋮ & ⋮ & ⋮ & ⋮ & ⋱ & ⋮ & ⋮ & ⋮ \\ 0 & 0 & 0 & 0 & 0 & 0 & 0 & 0 & 0 & … & 1 & {log}_{10} ( {SR}_{m , 1} ) & {[ {log}_{10} ( {SR}_{m , 1} ) ]}^{2} \\ & & & & & & & & & & & & \\ 0 & 0 & 0 & 0 & 0 & 0 & 0 & 0 & 0 & … & 1 & {log}_{10} ( {SR}_{m , 2} ) & {[ {log}_{10} ( {SR}_{m , 2} ) ]}^{2} \\ & & & & & & & & & & & & \\ ⋮ & ⋮ & ⋮ & ⋮ & ⋮ & ⋮ & ⋮ & ⋮ & ⋮ & ⋱ & ⋮ & ⋮ & ⋮ \\ 0 & 0 & 0 & 0 & 0 & 0 & 0 & 0 & 0 & … & 1 & {log}_{10} ( {SR}_{m , {n}_{m}} ) & {[ {log}_{10} ( {SR}_{m , {n}_{m}} ) ]}^{2} \\ & & & & & & & & & & & & \end{matrix} ] b = [ \begin{matrix}{WUS}_{0 , 1} \\ {WUS}_{0 , 2} \\ ⋮ \\ {WUS}_{0 , {n}_{0}} \\ {WUS}_{1 , 1} \\ {WUS}_{1 , 2} \\ ⋮ \\ {WUS}_{1 , {n}_{1}} \\ {WUS}_{2 , 1} \\ {WUS}_{2 , 2} \\ ⋮ \\ {WUS}_{2 , {n}_{2}} \\ ⋮ \\ {WUS}_{m , 1} \\ {WUS}_{m , 2} \\ ⋮ \\ {WUS}_{m , {n}_{m}}\end{matrix} ] \\ c = [ \begin{matrix}1 & {log}_{10} ( SR \text{?} ) & {[ {log}_{10} ( SR \text{?} ) ]}^{2} & - 1 & {}^{⋀} {log}_{10} ( SR \text{?} ) & {( {}^{⋀} ( {log}_{10} ( SR \text{?} ) ]}^{2} & 0 & 0 & 0 & … & 0 & 0 & 0 & 0 & 0 & 0 \\ & & & & & & & & & & & & & & & \\ 0 & 1 & {Z}_{( {log}_{10}} {}_{( SR \text{?} ) )} & 0 & - 1 & - {2}_{( {log}_{10} ( SR \text{?} ) )} & 0 & 0 & 0 & … & 0 & 0 & 0 & 0 & 0 & 0 \\ & & & & & & & & & & & & & & & \\ 0 & 0 & 0 & 1 & {log}_{10} ( SR \text{?} ) & {{log}_{10} ( SR \text{?} ) ]}^{2} & - 1 & - {log}_{10} ( SR \text{?} ) & - [ {log}_{10} {( SR \text{?} ) ]}^{2} & … & 0 & 0 & 0 & 0 & 0 & 0 \\ & & & & & & & & & & & & & & & \\ 0 & 0 & 0 & 0 & 1 & {2}_{( {log}_{10} ( SR \text{?} ) )} & 0 & - 1 & - {2}_{( {log}_{10} ( SR \text{?} ) )} & … & 0 & 0 & 0 & 0 & 0 & 0 \\ & & & & & & & & & & & & & & & \\ ⋮ & ⋮ & ⋮ & ⋮ & ⋮ & ⋮ & ⋮ & ⋮ & ⋮ & ⋱ & 0 & 0 & 0 & 0 & 0 & 0 \\ & & & & & & & & & & & & & & & \\ 0 & 0 & 0 & 0 & 0 & 0 & 0 & 0 & 0 & … & 1 & {log}_{10} ( SR \text{?} ) & {[ {log}_{10} ( SR \text{?} ) ]}^{2} & - 1 & - {log}_{10} ( {SR}_{10} ) & - {[ {log}_{10} ( {SR}_{10 \text{?}} ) ]}^{2} \\ & & & & & & & & & & & & & & & \\ 0 & 0 & 0 & 0 & 0 & 0 & 0 & 0 & 0 & … & 0 & 1 & {2}_{( {log}_{10} ( SR \text{?} ) ]} & 0 & - 1 & - {Z}_{( {log}_{10} ( {SR}_{10 \text{?}} ) ]}\end{matrix} ] \\ D = [ \begin{matrix}0 \\ \\ 0 \\ \\ 0 \\ \\ 0 \\ \\ ⋮ \\ \\ 0 \\ \\ 0\end{matrix} ] x = [ \begin{matrix}{x}_{0 , 0} \\ \\ {x}_{0 , 1} \\ \\ {x}_{0 , 2} \\ \\ {x}_{1 , 0} \\ \\ {x}_{1 , 1} \\ \\ {x}_{1 , 2} \\ \\ {x}_{2 , 0} \\ \\ {x}_{2 , 1} \\ \\ {x}_{2 , 2} \\ \\ ⋮ \\ \\ {x}_{m , 0} \\ \\ {x}_{m , 1} \\ \\ {x}_{m , 2}\end{matrix} ] \\ \text{?} \text{indicates text missing or illegible when filed}$$

where SR_{y,z}=the sales rank of data point z within regime y (i.e. having a SalesRank lying between breakpoint y−1 and y)
WUS_{y,z}=the WUS or interpolated WUS of data point z within regime y (i.e. having a sales rank lying between breakpoint y−1 and y)
SR_{bpy}=the sales rank at breakpoint x (i.e. breakpoint separating regimes y and y+1)
x_{y,0}=the constant-term parameter for the optimal constrained curve-fit for regime y
x_{y,1}=the linear-term parameter for the optimal constrained curve-fit for regime y
x_{y,2}=the quadratic-term parameter for the optimal constrained curve-fit for regime y

To determine a solution of a constrained least squares problem laid out as above, the computing device 101 may, for example, form the Lagrangian function, which, for example, may at the optimum solution point have zero slope in every direction. As such, the Karush-Kuhn-Tucker (KKT) conditions dictate that, for optimality, the matrices above may satisfy the condition:

$$[ \begin{matrix}2 {A}^{T} A & {C}^{T} \\ C & 0\end{matrix} ] [ \begin{matrix}\hat{x} \\ z\end{matrix} ] = [ \begin{matrix}2 {A}^{T} b \\ d\end{matrix} ]$$

where S is the optimal solution vector of curve-fit parameters x, and z is the vector of Lagrange multipliers. For example, the computing device 101 may invert the KKT matrix above to obtain the optimal solution to A via:

$$[ \begin{matrix}\hat{x} \\ z\end{matrix} ] = [ \begin{matrix}2 {A}^{T} A & {C}^{T} \\ C & 0\end{matrix} ] [ \begin{matrix}2 {A}^{T} b \\ d\end{matrix} ] .$$

For example, the computing device 101 may determine the optimal curve fit by running multiple iterative passes of the above matrix computation, and may, each time, exclude from the next computation individual data points that lie further than a first threshold factor (e.g., 1.5×) above and/or a second threshold factor (e.g., 0.5×) below the previous iteration's determined curve. While the example above uses 1.5× for the first threshold factor and 0.5× for the second threshold factor, in other examples, the threshold factors can be any number between 0.001-20). This may be done until the solution fully converges (e.g., there are no more outliers left or the number of outliers is below a threshold amount) or a pre-set maximum iteration count is reached. FIG. 8 shows an example graph 800 showing the optimal curve fit 805 based on the plotting of the graph 700 of data shown in FIG. 7. For example, the optimal curve fit may yield the following formulas for determining the period unit sales amount for each digital book of the plurality of digital books at the respective retailer within each regime or grouping:

$$Sales rank 1 - 100 : {log}_{10} ( WUS ) = 3.7039683510027 \; 652 - 0.1383533968917675 [ {log}_{10} ( SR ) ] - 0.08741441645870618 {( [ {log}_{10} ( SR ) ] )}^{2} \\ Sales rank 101 - 1 , 100 : {log}_{10} ( WUS ) = 4.934152964469581 - 1.0860241942268942 [ {log}_{10} ( SR ) ] + 0.07887482884125951 {( [ {log}_{10} ( SR ) ] )}^{2} \\ Sales rank 1 , 001 - 10 , 000 : {log}_{10} ( WUS ) = 3.7067352897607915 - 0.22312486349889582 [ {log}_{10} ( SR ) ] + 0.07237853976532449 {( [ {log}_{10} ( SR ) ] )}^{2} \\ Sales rank 10 , 000 - 100 , 000 : {log}_{10} ( WUS ) = 1.861352933842175 - 0.7359702687463141 [ {log}_{10} ( SR ) ] - 0.19681592558441707 {( [ {log}_{10} ( SR ) ] )}^{2} \\ Sales rank >= 100 , 001 : {log}_{10} ( WUS ) = - 34.41694386203669 + 15.6187 [ {log}_{10} ( SR ) ] - 1.72223 {( [ {log}_{10} ( SR ) ] )}^{2}$$

Those of ordinary skill in the art will recognize that the above formulas for the sales rank regimes or groupings are an example only and determined based on example sales rank and WUS or interpolated WUS data for a retailer. The formulas for other retailers, determined based on optimal curve fit would likely be different and vary from retailer to retailer.

At 616, a period unit sales amount may be determined for each digital book title for the retailer. For example, the determination may be made by the computing device 101 or any other computing device described herein. For example, the period unit sales amount may represent the estimated unit sales amount for the digital book title during the period (e.g., day, 24 hours, week, month, calendar quarter, year, etc.). For example, the period unit sales amount for the digital book title may be determined for the particular retailer and then summed together with the period unit sales amount for the digital book title for each other retailer of the plurality of retailers to get the period unit sales about for the digital book title. For example, the method 600 may be repeated for each other retailer of the plurality of retailers to obtain the period unit sales amount for each of the retailers for each particular digital book title. For example, the period unit sales amount for each digital book title may be determined based on digital book format for the particular digital book title.

For example, on a periodic (e.g., nightly, daily, weekly, monthly, quarterly, etc.) basis, the computing device 101 may determine period unit sales amount and total period sales value at the digital book title level for each e-book, audiobook, and printed-book sold online at each retailer tracked as described above. For example, the period unit sales amount may be determined by determining the current WUS or interpolated WUS for each digital book title in each format from its sales rank captured during the period using the most up-to-date calibrated optimal curve-fit for the particular retailer, as follows:

$${WUS}_{current} = 1 {0}^{( {x}_{0} + {x}_{1} [ {log}_{10} ( {SR}_{current} ) ] + {{x}_{2} ( [ {log}_{10} ( {SR}_{current} ) ] )}^{2} )}$$

where SR_{current}=the current sales rank (e.g., today's latest captured sales rank) for a given digital book title
X₀, X₁, and X₂=the most up-to-date constant, linear, and quadratic parameters computed for the book's retailer, format, and the sales rank regime that SR_{current} lies within
WUS_{current}=the current computed WUS for that book title in a particular digital book format
   Then, for each digital book title, its period unit sales amount may be determined by attenuating the previous WUS value stored for that digital book title in the prior period, and subtracting it from the current WUS for the current period to yield the digital book title's period unit sales amount:

$$Period Unit Sales Amount = {WSU}_{current} - ( {[ \frac{1}{{D}_{r , f}} ]}^{( {t}_{current} - {t}_{previous} )} {WUS}_{previous} )$$

where t_{current}=today's timestamp (today's last sales rank captured for a digital book title)
tₚᵣₑᵥᵢₒᵤₛ=yesterday's (or prior) timestamp (corresponding to timestamp of sales rank from which previous WUS was determined for that digital book title)
WUS_{current}=current period's determined WUS for the digital book title
WUSₚᵣₑᵥᵢₒᵤₛ=previous period's WUS determined for that book title
D_{r,f}=the retailer- and format-specific daily (or hourly) decay rate, which is the rate at which the contribution to a digital book title's WUS by older sales decays over time relative to the contribution of more recent sales to that digital book title's WUS.

In addition, the computing device 101 may determine a sales price for each particular digital book title of the plurality of digital book titles and each available digital book format for the respective digital book title. For example, the sales price may be determined from the plurality of digital book data received or retrieved from the book retailer websites 160A-C. For example, the sales price may be the same for each digital book format or may be different for one or more of the digital book formats for a respective digital book title for the retailer. The computing device 101 may determine a period sales value for each respective digital book title at each respective retailer of the plurality of retailers. For example, the period sales value may be determined based on the sales price for each respective digital book title and format for each respective retailer of the plurality of retailers and the period sales of each digital book title in the particular digital book format for that retailer. For example, the period sales value for a particular format of a digital book title may be determined by multiplying the period sales for the particular format of the digital book title at a retailer by the sales price for that digital book title in that format at that retailer. The period sales value for the digital book title may further be determined by summing the period sales value for each particular format of the digital book title at that retailer.

The computing device 101 may further determine the total period sales value for each respective digital book title of the plurality of digital book titles. For example, determining the total period sales value may be based on the period sales value for the particular respective book title of the plurality of digital book titles at each retailer of the plurality of retailers. For example, the computing device 101 may take the sum of all of the period sales values at all of the plurality of retailers that have sold the particular digital book title during the period to result in the total period sales value. The computing device 101 may create and or retrieve a record associated with the digital book title and add the total period sales value for the particular period into the record. The computing device 101 may further add or include in the record, the digital book metadata for the particular digital book title received or retrieved from the plurality of digital book data.

For each of the methods 200, 400, and 600 disclosed above, in addition to tracking period (e.g., daily, 24 hours, weekly, monthly) sales by individual book title, the computing device 101 may also perform certain additional periodic (e.g., nightly, weekly, monthly) determinations specifically to support queries that break down sales by hierarchical subgenre in each digital book format. For example, the computing device 101 may create a second, parallel data set that aggregates total sales for each subgenre and digital book format by date, publisher-type, sale price, and list price. A single digital book title will often be listed under a dozen or more subgenres (e.g., “Cozy Mystery”, “Historical Romance”, “Psychological Thriller”, etc.) that are applicable to that book's content (or that a publisher deems might be a good additional retail visibility booster for that book). When a digital book title is listed under a subgenre, it also appears in the hierarchical “parent” genres above that genre (e.g., a digital book title listed under “Psychological Thrillers” would also appear in parent category “Thrillers” and grandparent category “Mystery, Thriller & Suspense”; while a book listed under “Supernatural Horror” would also appear in parent category “Horror, grandparent category “Genre Fiction” and great-grandparent category “Literature & Fiction”). Thus it is necessary to avoid double, triple, quadruple,-counting sales when a digital book title is listed under multiple genres or subgenres.

The computing device 101 may create an expanded set of “book-title-by-deepest-subgenre” records for each digital book title of a particular digital book format in each genre, with one row for every deepest-level hierarchical subgenre each digital book title is listed under. This dataset may be a factor of 8×-10× larger than the one-record-per-digital-book-title title-level sales data, but each row associated with a digital book title contains only a proportionate fraction of that digital book title's projected unit and dollar sales. (e.g., if a digital book title is listed under 3 deepest-level subgenres, then each of these records will contain ⅓ of the digital book title's associated total unit sales and dollar sales; if a digital book title is listed under 7 deepest-level subgenres, then each of these records will contain 1/7 of the title's associated total unit sales and dollar sales; etc.).

Next, the computing device 101 may expand each row of this “digital-book-title-by-deepest-subgenre” dataset to include all of that subgenre's hierarchical parent subgenres, grandparent subgenres, etc., duplicating each record's deepest-level-subgenre's fractional unit sales and dollar sales to its parent and grandparent, etc. records, to create the “digital-book-title-by-all-genre-and-subgenre” dataset. This dataset is a factor of 3×-4× larger than the previous dataset, and thus a massive 25×-40× larger than one-record-per-book-title sales dataset. For example, if a digital book title is listed under three subgenres of “Mystery, Thriller and Suspense” (for example, “Psychological Thriller”, “Technothriller”, and “Hard Boiled Mystery”) and only one subgenre of “Literature & Fiction” (for example, “Historical Fiction”) then there will be three associated “Mystery, Thriller and Suspense” records for that title in the “digital-book-title-by-all-genre-and-subgenre” dataset, versus only one “Literature & Fiction” record. Thus, there will be a three times higher fractional portion of that digital book title's sales that will end up associated with “Mystery, Thriller and Suspense” than will be associated with “Literature & Fiction.”

For example, storing “digital-book-title-by-all-genre-and-subgenre” records permanently would require 25 times-40 times the storage requirements. Thus, the computing device 101 may instead aggregate “digital-book-title-by-all-genre-and-subgenre” records by subgenre, price, list price, and publisher type, resulting in a much more manageable secondary dataset that allows the computing device 101 to display or cause the display of a breakdown of sales by subgenre.

These two complementary data sets (digital-book-title-level daily sales and subgenre-level daily sales) may be determined by the computing device 101 on a periodic (e.g., nightly, daily, 24 hour, weekly, monthly, quarterly) basis for every digital book format in every area/market (e.g., city, state, country, group of countries, etc., for which digital book data is obtained, and then stored in both database form and a parallel indexed form that supports the real-time API and dashboard queries of the systems and methods disclosed herein.

For each of the methods 200, 400, and 600 disclosed above, in addition to the methods disclosed therein, each of the methods may further include an ability for the computing device 101 to receive a query (e.g., from a client device 170 via the network 140) and provide a response to the client device 170 via the network 140 that include digital-book-title-level period data determined above. To enable such efficient, real-time Boolean querying, filtering, and aggregation of the title-level daily data, the computing device 101 may, once each period's, digital-book-title-level data is determined and stored in the database 110 in its final form, the digital-book-title-level-data may be cloned into a noSQL document index 108. On a per-digital-book-title basis, parallel weekly, monthly, quarterly, and yearly aggregate records for that digital book title may be also determined by the computing device 101 at the end of each week, month, calendar quarter and year, and stored in the database 110 and the noSQL document index 108. The computing device 101 may include and expose a full-featured query API module 125 that allows very complex Boolean query and filter criterion to be specified in a request (e.g., from the client device 170), and return (e.g., to the client device 170) sales data that meets those criterion, rolled up at the specified entity level, which can be any one or more of digital book title, ISBN, retailer SKU, author, publisher, imprint, publisher type, narrator, or subgenre. Query criterion available via the query module 125 may include one or more of date range, subgenre, publisher type, publisher, imprint, author, narrator, title, subtitle, ISBN, retailer SKU, publication date range, price range, list price range, digital book format (e.g., e-book, audiobook, print book, hardcover, paperback, large format print, audio CD/DVD, etc.), availability or unavailability of certain other digital book formats for the digital book title, keywords in title or subtitle, wordstems in title or subtitle, keywords in author's name, wordstems in author's name, keywords in publisher or imprint name; wordstems in publisher or imprint name, keywords in narrator name, wordstems in narrator name, or any combination of the above.

The computing device 101 may further provide a dashboard API 127. For example, the dashboard API may comprise a web/mobile dashboard 127 that sits on top of the API and calls it directly, while providing an interactive, user-friendly interface. For example, when a client device 170 sends or submits a query to the computing device 101 via the dashboard 127 for less than 100,000 rows of returned data, the underlying noSQL document index 108 may handle the query and return the top 2,000 or top 10,000 or top 25,000 or top 50,000 rows that meet the query and filter criterion specified via a report generation module 129. The process takes seconds at most, and usually completes in less than a second.

For example, when a client device 170 sends or submits a “file download” request for the same data, the report generation module 129, for the computing device 101, may call the same API call asynchronously. The report generation module 129 may then format the data as requested (using, for example, custom Excel templates, CSV templates, or JSON templates). When the file is ready, the report generation module 129 or another portion of the computing device 101 may notify the client device via the dashboard API 127 and may provide a direct link for download of the file.

To support efficient query responses, regardless of whether the start and end dates specified are days apart or years apart, the computing device 101 may transparently decompose the specified date range into the optimal combination of distinct full-year, full-quarter, full-month, full-week, and single day time-periods that fully span the queried date range and result in the minimum number of time periods (and thus records) to aggregate for each digital book title. The query module 125 of the computing device 101 may determine the optimal set of time periods and then incorporate them into the query criterion on the back end without the knowledge of a user associated with the client device 170 making the query request. For example, if on Mar. 12, 2023, a query request is received from the client device 170 that requests the sales of the Top 100,000 e-books for the last 365 days, the corresponding date range Mar. 13, 2022-Mar. 12, 2023 may be deconstructed by the query module 125 into:
10 Daily timespans (Mar. 13, 28, 29, 30, and 31 in 2022+Mar. 1, 2, 3, 4, 5 in 2023)
3 Weekly timespans (Week of Mar. 14-20 and 21-27, 2022+Week of Mar. 6-12, 2023)
2 Monthly timespans (January 2023 and February 2023)
3 Quarterly timespans (Q2, Q3, and Q4 2022).
   In this example, only approximately 18 records per digital book title will need to be aggregated instead of the full 365, requiring 20-fold fewer computations (and thus yielding a 20-fold increase in speed) to provide digital book title-level sales totals for the last 365 days.

The user accounts, for the computing device 101, when provisioned, may allow login access to the web dashboard 127 and programmatic API for the computing device 101. However, by default, this may not, by itself, give that user account access to any data. Access to the underlying data may be controlled via client access rights 124, which may specify how many rows (if any) of each particular entity-level of sales data for each digital book format that a user associated with the client device 170 may access, depending on the scope of their search criterion. For example, the client access rights 124 for a user could limit the user to seeing the Top 39 selling e-books in a specific subgenre, and the Top 13 e-books in each sub-subgenre of that specific subgenre, yet only see the Top 7 e-books in other unrelated subgenres. The client access rights 124 for the same role or different role as the user could be permissioned to see only the Top 14 selling audiobook authors and Top 11 selling narrators for a specific named publisher, but no authors or narrators for any other publisher. Limits can be set separately for each country market's data (US, UK, etc.) as well as each digital book format (audiobook, e-book, printed-book). For example, if a user associated with the client device 170 and using the dashboard 127 does not have permission to see as many rows as the dashboard 170 shows by default, then, the disallowed rows (or graphs) may be blurred out on a display associated with the client device 170 and/or “locked” with an icon, and/or the data beneath may be randomized for security.

For each of the methods 200, 400, and 600 disclosed above, in addition to the methods disclosed therein, each of the methods may further include an ability for the computing device 101 to do cross-retailer same-digital-book-title linking and/or cross-format same-digital-book-title linking. For example, the vast majority of physical printed book titles have a unique identifier (e.g., the ISBN) that uniquely identifies that book as the same book across the many retailers that sell it. However, when it comes to digital book titles, the majority of digital book titles, including more than half of the top sellers, have no associated ISBN at all. Typically only large publishers reliably assign ISBNs to their digital book titles, while smaller publishers and self-publishers, who make up the majority of digital book title sales in many markets, do not. Further complicating the task of matching up the same digital book titles across different retailers, for even the roughly half of all digital book titles that do have ISBNs, most retailers do not display those ISBNs on their web product pages for those digital book titles. Metadata for digital book titles may also vary significantly by retailer, such as having different title and/or subtitle, different author punctuation and initialization, different listed page length, different audio listening length, etc.

The computing device 101 may solve the cross-retailer digital book-title matching problem as follows. First, based on a review of the received digital book data, if the computing device 101 determines that a new digital book title has a visible ISBN at one retailer, the computing device 101 may attempt to look up that ISBN at one or more other retailers of the plurality of retailers, and find matching SKUs between retailers for the same title that way. If no such match is found, the computing device 101 may generate fuzzy match scores based on metadata similarity (title words, author names, publisher and imprint names, publication dates, page lengths/listening length, etc.) to determine the top X (e.g., 3, 5, 10, 20, etc.) or so candidate digital book title matches at each one or more other retailers of the plurality of retailers. For example, the computing device 101 may determine the top X candidate digital book title matches at a retailer based on the fuzzy match score satisfying (e.g., greater than or greater than or equal to) a match score threshold. The computing device 101 may, for the determined top X candidate digital book title matches at the particular retailer and using image matching similarity algorithms, compare the associated cover artwork, and only consider a pair of book title SKUs at different retailers to be matched (e.g., represent the same book) if the cover-art matches to a level of similarity that satisfies (e.g., is greater than or greater than or equal to) an image similarity threshold.

In order to determine additional formats for a digital book title, the computing device 101 may identify or determine links to other formats of each digital book title on a retailer's book product pages for one digital book format of the digital book title. The computing device 101 may track these linkages and use them to match up the different digital book formats of each digital book title the computing device 101 tracks.

For each of the methods 200, 400, and 600 disclosed above, in addition to the methods disclosed therein, each of the methods may further include an ability for the computing device 101 to track the retailer sales rankings for preorder digital book titles that have not yet been released (e.g., have future publication dates). At each retailer, these sales rankings may be affected by preorder sales in the same manner as the sales rankings of already-released digital book titles are affected by regular sales. The computing device 101 may determine the corresponding weighted unit sales (WUS) and daily preorders for digital book titles that are unreleased but available for preorder at each retailer. The computing device 101 may treat preorders as if they all occurred on the digital book title's launch date (to ensure that publisher books that have accumulated a lot of preorders launch high on those lists in their official “release week”), known as “lumped preorder mode.” For example, the computing device 101 may hide all accrued preorders until the digital book title's release date, and may then include the accrued preorders with the actual sales of the digital book title on that release date.

In another example, the computing device 101 may assigns preorder sales with the dates those preorder sales were actually accrued, rather than assigning all of them with the digital book title's launch date. This allows users, via a client device 170, to see the pattern of preorder activity in the weeks/months before digital book title is released.

For each of the methods 200, 400, and 600 disclosed above, in addition to the methods disclosed therein, each of the methods may further include an ability for the computing device 101 to have a separate “Lifecycle” mode, where the user, via a request provided by the client device 170 and received by the computing device 101, can specify the same richness of query criterion, and the computing device can display or cause to be displayed at the client device 170 the average (or mean) sales of those digital book titles by the number of days, weeks, months, or quarters after publication. The computing device 101 can determine and display or cause to be displayed at the client device 170 average lifecycle sales stretching many years longer than the computing device 101 has been collecting data, by using a deep vertical analysis sample versus traditional longitudinal analysis. In essence, the computing device 101 may look at the average sales of digital book titles within a 30-day or 90-day sales sample and segment them by number of days/weeks/months/quarters since their individual publication date, and then aggregate and present averages (or means) for each book age accordingly.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving, by a computing device, a plurality of digital book data for a plurality of digital book titles for a period and associated with a retailer;
determining, based on the plurality of digital book data, daily sales data not available for at least one book format for the plurality of digital book titles;
determining, based on the plurality of digital book data, a first portion of the plurality of digital book titles in the at least one book format in a sub-genre sales ranking for the retailer;
determining, for each respective digital book title of the first portion of the plurality of book titles and based on the plurality of digital book data, a total sales ranking for that respective digital book title;
determining, based on the total sales ranking, a weighted unit sales amount for an upper bounding digital book title and a lower bounding digital book title in a particular digital book format in the subgenre sales ranking for each respective digital book title in the at least one book format;
determining, based on the weighted unit sales amount for the upper bounding digital book title and the lower bounding digital book title, an interpolated weighted unit sales amount for each respective digital book title in the at least one book format;
determining an optimal curve fit of the sales rank to the interpolated weighted unit sales amount for each digital book title of the plurality of digital book titles in the at least one format for the retailer; and
determining, based on the optimal curve fit for each book title of the plurality of book titles in the at least one format for the retailer, a period unit sales amount of each digital book title in the at least one format for the retailer.

2. The method of claim 1, wherein the period is one of 24 hours, a day, a week, a month, or a quarter of a calendar year.

3. The method of claim 1, further comprising:
determining, based on the plurality of digital book data, a sales price for each digital book title of the plurality of digital book titles for the retailer;
determining, based on the sales price for each respective digital book title and the period sales of each digital book title by each respective retailer, a period sales value for each respective digital book title at the retailer.

4. The method of claim 1, wherein the plurality of book data comprises one or more of a sale price, a list price, a total sales ranking, a genre sales ranking, or a subgenre sales ranking.

5. The method of claim 1, wherein the at least one book format comprises one or more of an audio book, an electronic book, or a print book.

6. The method of claim 1, wherein the plurality of digital book data comprises digital book title-level metadata.

7. The method of claim 1, wherein determining the optimal curve fit of the sales rank to the weighted unit sales amount for each digital book title of the plurality of digital book titles for each retailer of the plurality of retailers comprises:
receiving a unit sales amount for a portion of the plurality of digital book titles;
determining, based on the unit sales amount for the portion of the plurality of digital book titles, a decay rate for each digital book format for each retailer of the plurality of retailers, wherein the weighted unit sales is determined based on the decay rate;
graphically plotting the sales rank to the weighted unit sales for each digital book title of the plurality of digital book titles for a respective retailer of the plurality of retailers; and
determining, based on the plotting, the optimal curve fit for the respective retailer of the plurality of retailers.

8. An apparatus comprising:
one or more processors; and
memory storing processor-executable instructions that, when executed by the one or more processors, cause the apparatus to:
receive a plurality of digital book data for a plurality of digital book titles for a period and associated with a retailer;
determine, based on the plurality of digital book data, daily sales data not available for at least one book format for the plurality of digital book titles;
determine, based on the plurality of digital book data, a first portion of the plurality of digital book titles in the at least one book format in a sub-genre sales ranking for the retailer;
determine, for each respective digital book title of the first portion of the plurality of book titles and based on the plurality of digital book data, a total sales ranking for that respective digital book title;
determine, based on the total sales ranking, a weighted unit sales amount for an upper bounding digital book title and a lower bounding digital book title in a particular digital book format in the subgenre sales ranking for each respective digital book title in the at least one book format;
determine, based on the weighted unit sales amount for the upper bounding digital book title and the lower bounding digital book title, an interpolated weighted unit sales amount for each respective digital book title in the at least one book format;
determine an optimal curve fit of the sales rank to the interpolated weighted unit sales amount for each digital book title of the plurality of digital book titles in the at least one format for the retailer; and
determine, based on the optimal curve fit for each book title of the plurality of book titles in the at least one format for the retailer, a period unit sales amount of each digital book title in the at least one format for the retailer.

9. The apparatus of claim 8, wherein the period is one of 24 hours, a day, a week, a month, or a quarter of a calendar year.

10. The apparatus of claim 8, wherein the processor-executable instructions, when executed by the one or more processors, further cause the apparatus to:
determine, based on the plurality of digital book data, a sales price for each digital book title of the plurality of digital book titles for the retailer;
determine, based on the sales price for each respective digital book title and the period sales of each digital book title by each respective retailer, a period sales value for each respective digital book title at the retailer.

11. The apparatus of claim 8, wherein the plurality of book data comprises one or more of a sale price, a list price, a total sales ranking, a genre sales ranking, or a subgenre sales ranking.

12. The apparatus of claim 8, wherein the at least one book format comprises one or more of an audio book, an electronic book, or a print book.

13. The apparatus of claim 8, wherein the plurality of digital book data comprises digital book title-level metadata.

14. The apparatus of claim 8, wherein the processor-executable instructions that, when executed by the one or more processors, cause the apparatus to determine the optimal curve fit of the sales rank to the weighted unit sales amount for each digital book title of the plurality of digital book titles for each retailer of the plurality of retailers, cause the apparatus to:
receive a unit sales amount for a portion of the plurality of digital book titles;
determine, based on the unit sales amount for the portion of the plurality of digital book titles, a decay rate for each digital book format for each retailer of the plurality of retailers, wherein the weighted unit sales is determined based on the decay rate;
graphically plot the sales rank to the weighted unit sales for each digital book title of the plurality of digital book titles for a respective retailer of the plurality of retailers; and
determine, based on the plotting, the optimal curve fit for the respective retailer of the plurality of retailers.

15. One or more non-transitory computer-readable media storing processor-executable instructions that, when executed by at least one processor, cause the at least one processor to:
receive a plurality of digital book data for a plurality of digital book titles for a period and associated with a retailer;
determine, based on the plurality of digital book data, daily sales data not available for at least one book format for the plurality of digital book titles;
determine, based on the plurality of digital book data, a first portion of the plurality of digital book titles in the at least one book format in a sub-genre sales ranking for the retailer;
determine, for each respective digital book title of the first portion of the plurality of book titles and based on the plurality of digital book data, a total sales ranking for that respective digital book title;
determine, based on the total sales ranking, a weighted unit sales amount for an upper bounding digital book title and a lower bounding digital book title in a particular digital book format in the subgenre sales ranking for each respective digital book title in the at least one book format;
determine, based on the weighted unit sales amount for the upper bounding digital book title and the lower bounding digital book title, an interpolated weighted unit sales amount for each respective digital book title in the at least one book format;
determine an optimal curve fit of the sales rank to the interpolated weighted unit sales amount for each digital book title of the plurality of digital book titles in the at least one format for the retailer; and
determine, based on the optimal curve fit for each book title of the plurality of book titles in the at least one format for the retailer, a period unit sales amount of each digital book title in the at least one format for the retailer.

16. The one or more non-transitory computer-readable media of claim 15, wherein the period is one of 24 hours, a day, a week, a month, or a quarter of a calendar year.

17. The one or more non-transitory computer-readable media of claim 15, wherein the processor-executable instructions, when executed by the at least one processor, further cause the at least one processor to:
determine, based on the plurality of digital book data, a sales price for each digital book title of the plurality of digital book titles for the retailer;
determine, based on the sales price for each respective digital book title and the period sales of each digital book title by each respective retailer, a period sales value for each respective digital book title at the retailer.

18. The one or more non-transitory computer-readable media of claim 15, wherein the plurality of book data comprises one or more of a sale price, a list price, a total sales ranking, a genre sales ranking, or a subgenre sales ranking.

19. The one or more non-transitory computer-readable media of claim 15, wherein the at least one book format comprises one or more of an audio book, an electronic book, or a print book.

20. The one or more non-transitory computer-readable media of claim 15, wherein the processor-executable instructions that, when executed by the at least one processor, cause the at least one processor to determine the optimal curve fit of the sales rank to the weighted unit sales amount for each digital book title of the plurality of digital book titles for each retailer of the plurality of retailers, cause the at least one processor to:
receive a unit sales amount for a portion of the plurality of digital book titles;
determine, based on the unit sales amount for the portion of the plurality of digital book titles, a decay rate for each digital book format for each retailer of the plurality of retailers, wherein the weighted unit sales is determined based on the decay rate;
graphically plot the sales rank to the weighted unit sales for each digital book title of the plurality of digital book titles for a respective retailer of the plurality of retailers; and
determine, based on the plotting, the optimal curve fit for the respective retailer of the plurality of retailers.
